(19) United States
(12) Patent Application Publication
(10) Pub. No.: US 2022/0356292 A1
(43) Pub. Date: Nov. 10, 2022

(54) USES OF MICROBIAL DERIVED MATERIALS IN THERMOSET APPLICATIONS

(71) Applicant: Checkerspot, Inc., Alameda, CA (US)

(72) Inventors: Matthew STERBENZ, Salt Lake City, UT (US); Daniel MALMROSE, Salt Lake City, UT (US); Jian HONG, Pittsburg, KS (US); Dragana RADOJCIC, Peshtigo, WI (US); Scott FRANKLIN, Woodside, CA (US); Charles RAND, Salt Lake City, UT (US)

(21) Appl. No.: 17/871,187

(22) Filed: Jul. 22, 2022

Related U.S. Application Data
(63) Continuation of application No. PCT/US21/14662, filed on Jan. 22, 2021.
(60) Provisional application No. 63/088,600, filed on Oct. 7, 2020.
(60) Provisional application No. 62/965,681, filed on Jan. 24, 2020.

(51) Int. Cl. C08G 18/34; C08G 18/20; B29C 39/02; B29C 39/00

(52) U.S. Cl. CPC C08G 18/348; C08G 18/2063; B29C 39/02; B29C 39/003; B29K 2075/00

(57) ABSTRACT

This disclosure provides methods for the chemical modification of microbial derived triglyceride oils, use thereof in polyurethane chemistries, and incorporation thereof in the production of sporting goods equipment, including, for example, alpine skis, touring skis, cross country skis, approach skis, split boards, snowboards, surfboards, paddleboards, and water skis.

### CROSS-REFERENCE

This application is a continuation of PCT/US21/14662 filed Jan. 22, 2021, which claims the benefit of U.S. Provisional Application No. 63/088,600, filed Oct. 7, 2020, and U.S. Provisional Application No. 62/965,681, filed Jan. 24, 2020, each of which is incorporated herein by reference in its entirety.

### BACKGROUND

Polyurethanes (PU) can be produced via the condensation of a hydroxyl functionality, such as a polyol, with an isocyanate moiety. As a polymer class, polyurethanes are quite diverse and unique among plastics as the chemical structure of polyurethanes is not a highly repetitive unit. As a consequence, polyurethanes having the same general physical properties can have dramatically different chemical compositions. Because of their diverse structural makeup, polyurethanes come in myriad forms and are used for the production of resins, films, coatings, hard and soft foams, sealants, adhesives, and elastomers.

Most polyols are typically derived from petroleum feedstocks. However, as the global climate continues to warm, and with little doubt remaining as to the direct correlation between the increased utilization of fossil fuels over the past millennium and the imminent threat posed by a warming climate, there is an urgent need to replace incumbent, petroleum derived fuels and chemicals with more sustainable, renewable materials. The polyol components of polyurethanes present an opportunity for renewable alternatives with novel functionalities.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In some aspects, the present disclosure provides a method for producing a cast polyurethane resin, the method comprising preparing a reaction mixture that comprises:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol,
   thereby producing the cast polyurethane resin.

In some aspects, the present disclosure provides a cast polyurethane resin produced by a method described herein.

In some aspects, the present disclosure provides a reaction mixture comprising:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.

In some aspects, the present disclosure provides a cast polyurethane resin comprising:
a) a polyol component at an amount of about 50% to about 75% on a weight-by-weight basis of the cast polyurethane resin;
b) an isocyanate component at an amount of about 25% to about 40% on a weight-by-weight basis of the cast polyurethane resin;
c) a catalyst component at an amount of about 0.1% to about 1% on a weight-by-weight basis of the polyol; and
d) a zeolite at an amount of about 0.1% to about 8% on a weight-by-weight basis of the polyol.

In some aspects, the present disclosure provides a method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin and a zeolite at an amount of about 0.1% to about 8% on a weight-by-weight basis of the polyol in the presence of a catalyst at an amount of about 0.1% to about 1% on a weight-by-weight basis of the polyol, thereby preparing the cast polyurethane resin.

In some aspects, the present disclosure provides a sporting goods equipment comprising a cast polyurethane resin derived from a microbial oil.

In some aspects, the present disclosure provides a method of producing a sporting goods equipment comprising a cast polyurethane resin derived from a microbial oil, comprising: (a) polymerizing a polyol derived from the microbial oil with an isocyanate, thereby generating the polyurethane resin; and (b) incorporating the polyurethane resin to one or more components of the sporting goods equipment to produce the sporting goods equipment.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1, Panel A illustrates a top view of an example algal polyurethane composite core alone, without the additional materials of construction. Panel B illustrates a cross sectional view of algal polyurethane composite core as shown in Panel A alone, without the additional materials of construction. Panel C illustrates an example ski contour design. Panel D illustrates the ski contour design as shown in Panel C, overlaid on an algal polyurethane composite core. Panel E illustrates a side view of the algal polyurethane composite cores shown in Panel D. Panel F illustrates cross sectional views at tip, waist, and tail of an example algal polyurethane composite core alone, without the additional materials of construction. Panel G illustrates a cutaway view of the sandwich construction of a ski, including an example algal polyurethane composite core, cast urethane sidewalls and additional materials of construction. Panel H illustrates cross sectional views at tip, waist, and tail of an example algal polyurethane composite core with cast urethane sidewalls as well as additional materials of construction.

FIG. 2, Panel A illustrates the results (stress strain curves) of tensile strength testing of QC cast urethanes at room temperature (RT). Panel B illustrates the results (stress strain curves) of tensile strength testing of QC cast urethanes at 0-2° C. (LT).

FIG. 3, Panel A illustrates the results of three-point bend testing of QC cast urethanes at RT. Panel B illustrates the results of three-point bend testing of QC cast urethanes at 0-2° C. (LT).

FIG. 4, Panel A illustrates the results (stress strain curves) of tensile strength testing of SC cast urethanes at RT. Panel B illustrates the results (stress strain curves) of tensile strength testing of SC cast urethanes at 0-2° C. (LT).

FIG. 5, Panel A illustrates the results of three-point bend testing of SC cast urethanes at RT. Panel B illustrates the corresponding results at 0-2° C. (LT).

### DETAILED DESCRIPTION

Provided herein are methods for generating polyols from microbial derived oils having some degree of unsaturation. These polyols can subsequently be reacted with an isocyanate to generate a polyurethane. Polyurethanes can serve as excellent thermoset resin materials because of their pourability at room temperature. Because these polyurethanes are a fluidic state at room temperature, they do not require melting prior to incorporating into a component of a final product. Depending upon formulation, curing of polyurethane resins can be accomplished at room temperature, with the addition of heat or light, or with addition of a curing agent. Microbial derived, pourable thermoset resins, alone or in combination with other materials, can have a variety of material applications in consumer goods, such as skis, snowboards, skateboard, surfboards, paddleboards, wakeboards, kiteboards, and split boards.

As used herein, the term “hydroformylated” or “hydroformylation” refers to the sequential chemical reactions of hydroformylation (across C═C double bonds) to produce an aldehyde, followed by hydrogenation (of the resulting aldehyde) to produce an alcohol unless indicated otherwise.

As used herein, the term “triacylglycerol”, “triglyceride”, or “TAG” refers to esters between glycerol and three saturated and/or unsaturated fatty acids. Generally, fatty acids comprising TAGs have chain lengths of at least 8 carbon atoms up to 24 carbons or more.

As used herein, the term “biobased” generally refers to materials sourced from biological products or renewable agricultural material, including plant, animal, and marine materials, forestry materials, or an intermediate feedstock.

As used herein, the term “microbial oil” refers to an oil extracted from a microbe, e.g., an oleaginous, single-celled, eukaryotic or prokaryotic microorganism, including, but not limited to, yeast, microalgae, and bacteria.

As used herein, the term “polyol”, “biopolyol”, “natural oil polyol”, or “NOP” refers to triglycerols or fatty acid alcohols comprising hydroxyl functional groups. As used herein, the term “polyol derived from a TAG oil” generally refers to a polyol obtained from chemical conversion of a TAG oil, e.g., via epoxidation and ring opening, ozonolysis and reduction, or hydroformylation and reduction.

As used herein, the term “polyurethane”, “PU”, or “urethane” refers to a class of polymers comprised of carbamate (urethane) linkages formed between a polyol and an isocyanate moiety.

As used herein, the term “TAG purity”, “molecular purity”, or “oil purity” refers to the number of molecular species that make up an oil composition, on an absolute basis or present in amounts above a certain threshold. The fewer the number of TAG species in an oil, the greater the “purity” of the oil. In some embodiments, a pure oil may be an oil comprising up to 9 TAG species and 60% of more of triolein. In some embodiments, a pure oil may comprise up to 4 TAG species present in amounts of above a certain threshold in the oil (e.g., ruling out trace amounts of other TAG) and 90% or more of a single TAG species, such as triolein.

As used herein, the term “oleic content” or “olein content” refers the percentage amount of oleic acid in the fatty acid profile of a substance (e.g., a polyol). As used herein, the term “C18:1 content” refers the percentage amount of a C18:1 fatty acid (e.g., oleic acid) in the fatty acid profile of a substance (e.g., a polyol).

As used herein, the term “hydroxyl number” or “OH #” of the resulting polyol refers to the number of milligrams of potassium hydroxide (mg KOH/g) required to neutralize the acetic acid taken up on acetylation of one gram of a substance (e.g., a polyol) that contains free hydroxyl groups. The hydroxyl number is a measure of the content of free hydroxyl groups in the substance. The hydroxyl number can be determined by ASTM E1899.

As used herein, the term “blowing agent” refers to a substance that produces a gas during the hardening or phase transition of polymers described herein, and as such leads to the formation of a resulting cellular structure.

As used herein, the term “de-mold time” or “demolding time” refers to the amount of time in which a casting solidifies to a point in which the casting can be removed from a mold. Generally, a casting is not yet fully cured after the de-mold time.

As used herein, the term “cure time” or “curing time” refers to the amount of time in which chemical crosslinking of a casting is complete and the physical properties of the casting do not change over time, e.g., viscosity, glass transition temperature (T_{g}), strength. Curing time can be accelerated by the addition of heat.

As used herein, the term “about” refers to ±10% from the value provided.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are described herein.

### Construction of Skis and Other Sporting Goods Equipment

Skis, snowboards, and other sporting goods equipment can be composed of a core material surrounded by a top layer and a bottom layer, and reinforced by sidewalls.

The top layer can be composed of layers of plastic and/or fibrous materials, for example, wood, fiberglass, carbon fiber, Kevlar, flax, hemp, or wool.

The bottom layer can be composed of layers of plastic, polyethylene, fiberglass, as well as elastomeric materials. Non-limiting examples of elastomeric materials include polyethylene, rubber, and neoprene. The bottom layer includes a base layer, which can be composed of polyethylene with a metal edge. Non-limiting examples of metals include steel, titanium, aluminum, and an alloy thereof. In some embodiments, the metal edge is composed of steel with a Rockwell Hardness in the range of HRC 45-60. A layer of elastomeric material can sit atop the metal edge, which can help dampen vibrations arising from the metal. In some embodiments, the base layer does not include a metal edge. The sidewall can refer to an area along the edge of a ski above the metal edge that laterally reinforces the core material.

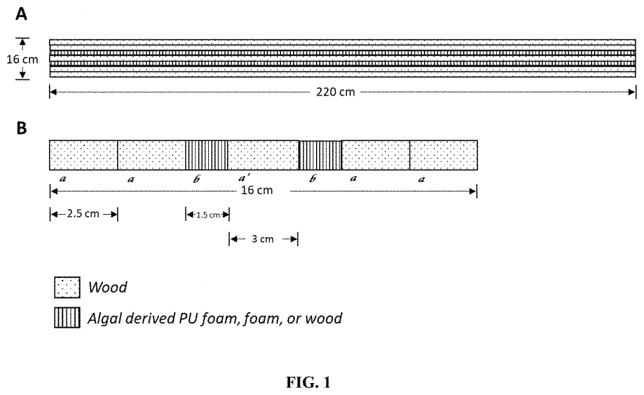

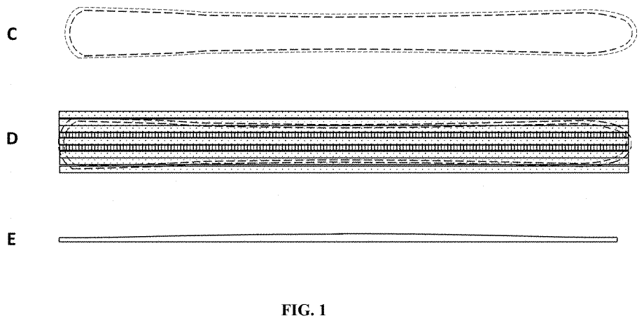

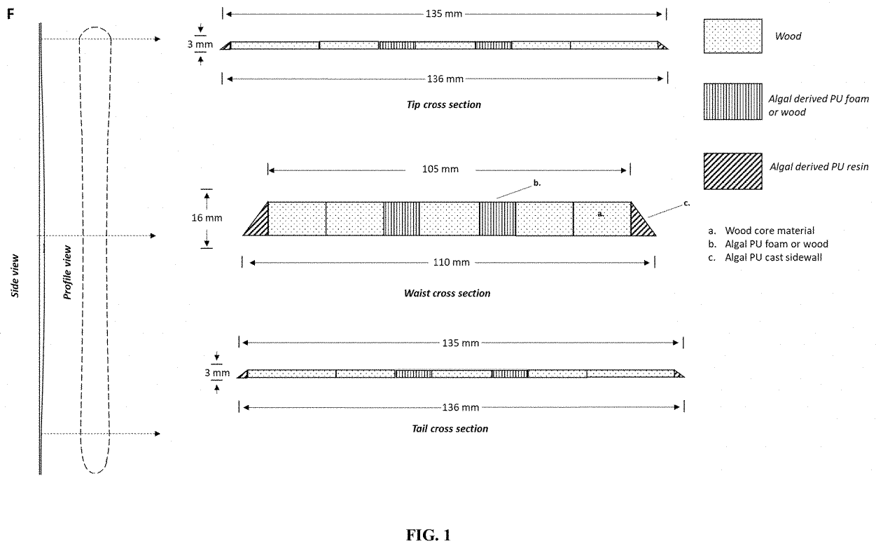

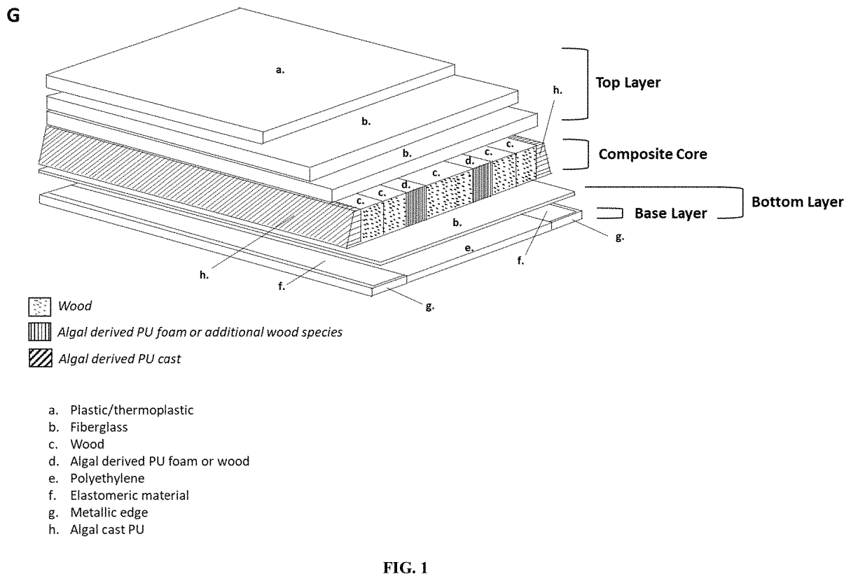

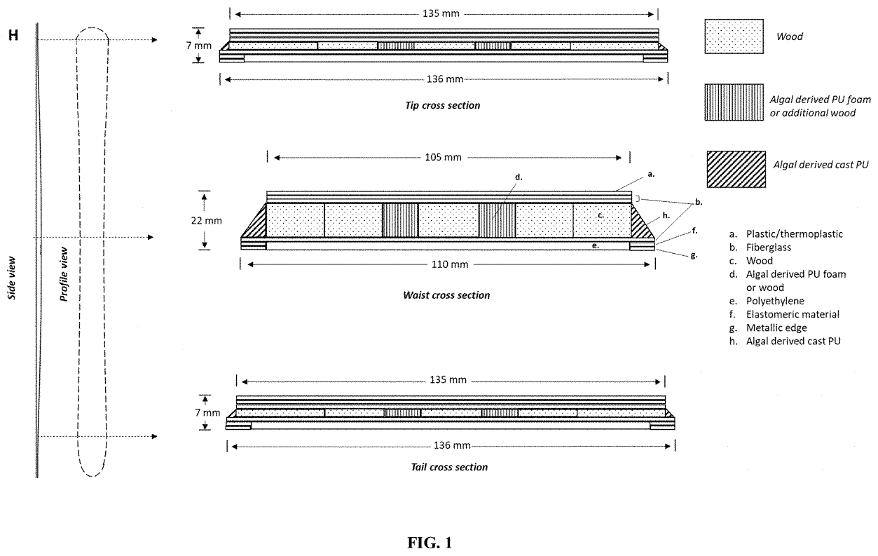

FIG. 1, Panel G illustrates a cutaway view of an example ski having an example algal polyurethane composite core. The top sheet (a) is a plastic-like material, including, but not limited to, thermoplastic, polyurethane, ABS, TPU/ABS co-polymer, high molecular weight polyethylene, nylon, and polybutylene terephthalate (PBT). Below top sheet a is one or more layers of fiberglass or other fibrous material, such as plant or animal derived fibers (b). Fiber types include, for example, flax, hemp, and wool. The following core composite layer is the algal PU wood composite (c and d), which is flanked by two algal cast PU sidewalls (h). The composite core is underpinned by one or more additional layers of fiberglass or other fibrous material. The base layer or bottom sheet (e) is composed of polyethylene. The base layer also includes a metal edge (g). A layer of elastomeric material (f) sits atop the metal edge and functions to dampen vibrations that arise from the metal. The elastomeric material can be composed of rubber or neoprene.

The core material can be composed of various materials, including wood and a hydrophobic material overlaid with fiberglass and a resin that provides strength and rigidity. The resins can be an epoxy based resin or a polyurethane resin. In some embodiments, the resin is a cast polyurethane resin derived from microbial oil. In some embodiments, the core material of a sporting goods equipment described herein can be a composite material containing polyurethane foam and a solid material. The composite material can be composed of alternating layers of polyurethane foam and a solid material. A solid material can be a plastic, a fibrous material, a metal, an elastomeric material, or a thermoset material. Non-limiting examples of plastic include polyurethane, polyethylene, and thermoplastic. Non-limiting examples of metals include steel, titanium, aluminum, or an alloy thereof. Non-limiting examples of a fibrous material include wood, fiberglass, carbon fiber, Kevlar, flax, hemp, or wool.

In some embodiments, the core material is composed of polyurethane and one of more species of wood. Wood varieties vary in weight, strength, and flexibility. For example, paulownia is ultra-lightweight, but tends not to dampen vibrations as well as other woods. Beech, maple, ash and fir, for example, are denser and burlier than other types and thus, provide great torsional rigidity and stability. Non-limiting examples of wood types include paulownia (for example, Paulownia sp.), cherry (for example, Prunus sp.), birch (for example, Betula sp.), alder (for example, Alnus sp.), fuma (for example, Ceiba sp.), ash (for example, Fraxinus sp.), box elder (for example, Acer negundo), chestnut (for example, Castanea sp.), elm (for example, Ulmus sp.), hickory (for example, Carya sp.), koa (for example, Acacia sp. and Acacia koa), mahogany (for example, Swietenia sp.), sweetgum (for example, Liquidambar sp.), oak (for example, Quercus sp.), ash (for example, Fraxinus sp.), aspen (for example, Populus tremuloides), beech (for example, Fagus sp.), maple (for example, Acer sp.), poplar (for example, Populus sp.), walnut (for example, Juglans sp.), pine (for example, Pinus sp.), cedar (for example, Cedrus sp. and Libocedrus sp.), yew, fir (for example, Abies sp.), Douglas fir (for example, Pseudotsuga menziesii), larch (for example, Larix sp.), hardwood, bamboo (for example, Bambusoideae sp.), blackwood, bloodwood, basswood, boxelder, boxwood, brazilwood, coachwood, cocobolo, corkwood, cottonwood, dogwood, ironwood, kingwood, lacewood, marblewood, sandalwood, rosewood, zebrawood, ebony, ivory, buckeye, satinwood, kauri, spruce (for example, Picea sp.), cypress (for example, Taxodium sp.), hemlock (for example, Tsuga sp.), redwood (for example, Sequoia sp. and Sequoiadendron sp.), rimu, teak (for example, Tectona sp.), eucalyptus, and willow (Salix). In some embodiments, the core material is composed of polyurethane and paulownia. In some embodiments, the core material is composed of polyurethane and aspen. In some embodiments, the core material is composed of polyurethane, paulownia, and aspen.

In some embodiments, the composite material can be composed of alternating strips of wood and polyurethane foam that are longitudinally layered along the length of the strips. Each strip can be affixed to one another by an adhesive or bonding material. Non-limiting examples of adhesives include a polyvinyl acetate based adhesive, an ethylene vinyl acetate based adhesive, a polyurethane based adhesive, a urea-formaldehyde based adhesive, a melamine based adhesive, and a silicone based adhesive. In some embodiments, the strips of a composite can be laminated together with a resin and/or heat. The resin can be an epoxy resin.

In some embodiments, the core material can be comprised entirely of wood.

In some embodiments, the core material can be comprised entirely of polyurethane foam.

In some embodiments, a polyurethane foam can contain a polyol derived from algal oil.

Heavy skis can be unwieldy and reduce the responsiveness and utility in many applications of these equipment. For example, backcountry skiers or ski mountaineers must ascend on skis using their own locomotion, often for several thousand vertical feet, in difficult terrain to attain sufficient altitude from which to descend. Thus, lightweighting can be a critical factor in the design of high quality and functional ski equipment.

Solid wood cores made of glue-laminated lamellae are commonly used in ski core equipment. Solid wood cores provide desirable strength and flexural (bending) properties, and come in a variety of types, grains, and densities. Flexural properties are defined as the ability to resist fracture, as described, for example, in ASTM D790. Lamination of wood strips that differ in density and strength allows for optimization for strength and weight of the lamellae.

Sidewalls can provide protection and support to the core of a sporting goods equipment. The sidewall of sporting goods equipment serves as an impervious barrier to the elements and prevents ingress of elements to the core material. Ingress of elements to the core material of a sporting goods equipment is a main contributor to deterioration and mechanical failure of the equipment. Thus, the construction and composition of the sidewall material are critical to the proper functioning and maintenance of sporting goods equipment.

The sidewall barrier is particularly important for backcountry ski applications. Backcountry skiers often ski solo over open and rocky terrain, and heavily depend on the durability of the skis. Thus, sturdy sidewall materials are required for practical applications of backcountry skis.

Additionally, the strength of the sidewall is critical at the area underfoot, at the edge of the ski. During cornering and breaking, the ski edge, and by extension, the sidewall, experience the greatest load as the skier's weight and the associated force exert maximal force on the ski edge.

Typically, ski sidewall materials are composed of ABS (acrylonitrile butadiene styrene), UHMWPE (ultra-high molecular weight polyethylene), or HDPE (high density polyethylene). These materials are received as strips or sheet stock, and then cut to the appropriate dimensions for incorporation into the ski. This method can be more laborious and results in the accumulation scrap materials, which can be wasteful and environmentally unsustainable.

An alternative method of creating sidewall material is using a pourable polyurethane. Pourable polyurethane allows for assembly of sidewalls and other materials using the wooden ski core as a mold, and thereby obviates the cutting step prior to assembly of a final product. In some embodiments, the pourable polyurethane is derived from microbial oil, for example, an algal oil. Utilization of a cast urethane sidewall material with an algal derived polyol affords the opportunity to create myriad formulations that cannot be obtained with other products whose physical properties are fixed. In addition, utilization of a cast urethane and its incorporation as a sidewall material allows for control of the depth and thickness, both of which can impart performance properties on the finished ski while minimizing the amount of material used.

Unlike incumbent materials, such as ABS, UHMWPE, or HDPE, a pourable polyurethane provides the additional benefit of forming an intimate bond with an adjacent wood core. The free hydroxyl groups present in the cellulosic wood core bond to free isocyanate groups in the polyurethane, thereby forming covalent bonds with the polymer network. Incumbent materials, on the other hand, require the application of a separate adhesive such as an epoxy, for example, to adhere to the wood.

From a sustainability and greenhouse gas (GHG) emissions perspective, incumbent sidewall materials made from petroleum-based, non-renewable, and net GHG emitting materials, such as ABS, UHMWPE, and HDPE, are not ideal. Replacement of these unsustainable materials with a biobased, cast PU material derived from renewable materials offers a solution to the shortcomings of conventional methods of polyurethane production.

Using the cast urethane approach, the core material (FIG. 1, Panel A, top view) and (FIG. 1, Panel B, side view) is channeled (FIG. 1, Panel C, top view channel outline and FIG. 1, Panel D, top view channel outline overlaid on core) such that the core material serves as a mold to receive the pourable urethane. Final dimensions of the pourable urethane can be determined through planing and computer numerical control (CNC) routing. The resulting sidewall material is fully integrated with the profiled core (FIG. 1, Panel E). The uniform integration of the sidewall material and the core composite is attributed to reaction of the cast urethanes with the sugar moieties in the cellulose forming urethane linkages of the polyurethane composite. In addition, because the cast urethane is flowable prior to curing and/or setting, the cast urethane can follow into vessels (for example, in softwoods) and tracheids (for example, in hardwoods), thereby allowing for much greater penetration of the sidewall material into the core as compared to sidewall materials that are bonded to the core by the epoxy resins alone.

FIG. 1, Panel F illustrates side, profile and cross sectional views (at tip, waist and tail) of a core composite created with a cast urethane sidewall and showing the relative contribution of the cast sidewall material at each cross sectional area. FIG. 1, Panel G illustrates a cutaway view of an example ski composition, containing materials of construction including cast sidewall material. The components of the ski shown in FIG. 1, Panel G can be assembled, layer by layer, into a metal mold with the application of an epoxy resin and hardener.

The top sheet (a.) can be composed of one or more plastic-like materials including, but not limited to, thermoplastic polyurethanes (TPUs), ABS, TPU/ABS co-polymers, high molecular weight polyethylene, nylon, and polybutylene terephthalate (PBT).

The top sheet can be followed by one or more sheets of a fibrous material (b.). Non-limiting examples of fibrous materials include fiberglass, carbon fiber, Kevlar, and plant or animal based fiber-based materials, for example, flax, hemp, and wool.

The bottom layer is typically comprised of a bottom sheet (e.) made of a variety of plastics, for example, high molecular weight polyethylene. For sporting goods equipment such as skis, splitboards, and snowboards, the base also contains a ski edge (g.), which is often comprised of metal. In some embodiments, the metal is steel with a Rockwell Hardness in the range of HRC 45-60. A layer of elastomeric material (f.) sits atop the metal edge and functions to dampen vibrations that arise from the metal. The elastomeric material can be composed of rubber or neoprene.

The components of the ski can be affixed together by an epoxy resin and assembled in a mold. In some embodiments, a sporting goods equipment or a component thereof can be assembled in a mold in the presence of heat, pressure, or both.

FIG. 1, Panel H illustrates side, profile, and cross sectional views (at tip, waist and tail) of a ski created with a cast urethane sidewall and showing the relative contribution of the cast sidewall material at each cross sectional area along with the other materials of construction shown in FIG. 1, Panel G.

### Polyurethane Compositions

In some embodiments, a polyurethane resin described herein contains a polyol; an isocyanate; and a catalyst.

The polyol can be in an amount of about 50% to about 75% on a weight-by-weight basis of the resin. In some embodiments, the polyol is at an amount of about 54% to about 72% on a weight-by-weight basis of the resin. For example, the polyol is at an amount of about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75%.

In some embodiments, the polyol is derived from a microbial triglyceride oil. In some embodiments, the polyol is derived from an algal triglyceride oil. In some embodiments, the polyol is derived from epoxidized triglyceride oil. In some embodiments, the polyol is derived from epoxidized and ring opened triglyceride oil. In some embodiments, the polyol is derived from hydroformylated triglyceride oil. In some embodiments, the polyol is derived from hydroformylated and hydrogenated triglyceride oil.

In some embodiments, a polyol has a C18:1 content of at least 60%, at least 70%, at least 80%, or at least 90%. For example, a polyol has a C18:1 content of about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or more.

The isocyanate can be in an amount of about 25% to about 40% on a weight-by-weight basis of the resin. In some embodiments, the isocyanate is at an amount of about 28% to about 38% on a weight-by-weight basis of the resin. For example, the isocyanate is about 25%, about 26%, about 27%, about 28%, about 29%, about 30%, about 31%, about 32%, about 33%, about 34%, about 35%, about 36%, about 37%, about 38%, about 39%, or about 40%.

In some embodiments, the isocyanate is a monomeric isocyanate or a polymeric isocyanate. Non-limiting examples of monomeric isocyanates include Rubinate® 44 and Rubinate® 9225. Non-limiting examples of polymeric isocyanates include polymeric methylene diphenyl diisocyanate (MDI) and Rubinate® M. Non-limiting examples of isocyanates include methylenebis(phenyl isocyanate) (MDI), toluene diisocyanate (TDI), and hexamethylene diisocyanate (HDI), naphthalene diisocyanate (NDI), methylene bis-cyclohexylisocyanate (HMDI)(hydrogenated MDI), and isophorone diisocyanate (IPDI).

The catalyst can be in an amount of about 0.1% to about 1%, about 0.5% to about 0.8%, or about 0.1% to about 0.5% on a weight-by-weight basis of the polyol. For example, the catalyst is at an amount of about 0.1%, about 0.2%, about 0.3%, about 0.4%, about 0.5%, about 0.6%, about 0.7%, about 0.8%, about 0.9%, or about 1% on a weight-by-weight basis of the polyol.

In some embodiments, the catalyst is an amine catalyst, a primary amine catalyst, a secondary amine catalyst, a tertiary amine catalyst, an organometallic catalyst, an organotin catalyst, an organozinc catalyst, or an organozirconium catalyst. In some embodiments, the catalyst is a tertiary amine catalyst. In some embodiments, the catalyst is 1,4-diazabicyclo[2.2.2]octane (DABCO). In some embodiments, the catalyst is an organotin catalyst. In some embodiments, the catalyst is dibutyltin dilaurate (DBTDL).

Zeolites are hydrated aluminosilicate minerals containing alkali or alkaline metals (e.g., sodium, potassium, calcium, and magnesium) plus water molecules trapped in the gaps between them. The open, cage-like, crystal structure of zeolites allow for trapping of other molecules therein, and thus, are useful as molecular sieves and drying agents.

In some embodiments, a polyurethane resin further contains zeolites at an amount of about 0.1% to about 8% on a weight-by-weight basis of the polyol. For example, the zeolites is an amount of about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, about 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, or about 8%.

In some embodiments, a polyurethane resin further contains an alkyl diol. Non-limiting examples of alkyl diols include 1,3-propanediol; 1,4-butanediol; and 1,6-hexanediol. The alkyl diol can be at an amount of about 0.1% to about 10% on a weight-by-weight basis of the polyol. For example, the alkyl diol is an amount of about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, about 8%, about 8.1%, about 8.2%, about 8.3%, about 8.4%, about 8.5%, about 8.6%, about 8.7%, about 8.8%, about 8.9%, about 9%, about 9.1%, about 9.2%, about 9.3%, about 9.4%, about 9.5%, about 9.6%, about 9.7%, about 9.8%, about 9.9%, or about 10%.

### Methods of Production

In some embodiments, a sporting goods equipment or component thereof can be produced by casting a polyurethane resin into a mold comprising a composite material such that the resin adheres to the composite material and takes on the shape of the mold. After casting, the polyurethane resin can be cured at a temperature of from 20° C. to 110° C. or from 20° C. to 25° C., for example, at 20° C., at 25° C., at 30° C., at 35° C., at 40° C., at 45° C., at 50° C., at 55° C., at 60° C., at 65° C., at 70° C., at 75° C., at 80° C., at 85° C., at 90° C., at 100° C., or 110° C. In some embodiments, the polyurethane resin can be cured at room temperature (e.g., about 25° C.). In some embodiments, the polyurethane resin can be cured at room temperature (e.g., about 25° C.) for at least 48 hours. In some embodiments, the polyurethane resin can be cured by heat. In some embodiments, the polyurethane resin can be cured at about 75° C. for at least 30 minutes. In some embodiments, the polyurethane resin can be cured at about 110° C. for at least 15 hours. In some embodiments, the polyurethane resin can be cured at a temperature that is not greater than 25° C. In some embodiments, the polyurethane resin can be cured at a temperature that is not greater than 110° C.

Curing time can affect the physical properties of a cast polyurethane resin product. In some embodiments, the polyurethane resin can be cured for about 30 minutes to about 4 hours, for example, about 30 minutes, about 45 minutes, about 1 hour, about 1.5 hours, about 2 hours, about 2.5 hours, about 3 hours, about 3.5 hours, or about 4 hours. In some embodiments, the polyurethane resin can be cured for less than 30 minutes.

In some embodiments, the polyurethane resin can be cured for about 16 hours to about 48 hours, for example, about 16 hours, about 17 hours, about 18 hours, about 19 hours, about 20 hours, about 21 hours, about 22 hours, about 23 hours, or about 24 hours. In some embodiments, the polyurethane resin can be cured for longer than 24 hours. In some embodiments, the polyurethane resin can be cured for at least 48 hours.

In some embodiments, the polyurethane resin can be cured at room temperature for a sufficient time to impart optimal mechanical properties, for example, such that one or more properties of the polyurethane resin does not change over time (e.g., T_{g}, strength, flexibility). The cured resin exhibits a variety of physical properties based on the method of production. Cast urethane formulations can be characterized by various metrics, including tensile strength, elongation at break, flexural strength, break stress, glass transition temperature, Shore hardness, and biobased content. Some of these parameters can be assessed at various temperatures dependent upon the application of the polyurethane resin. For example, a polyurethane resin can be assessed at low temperature (e.g., 0-2° C.), room temperature (e.g, about 25° C.), or high temperature.

In some embodiments, the polyurethane resin has a tensile strength of 560 psi or more. In some embodiments, the polyurethane resin has a tensile strength of 1,015 psi or more. In some embodiments, the polyurethane resin has a tensile strength of 2,000 psi or more. In some embodiments, the polyurethane resin has a tensile strength of 3,000 psi or more. In some embodiments, the polyurethane resin has a tensile strength of 4,000 psi or more. In some embodiments, the polyurethane resin has a tensile strength of 5,000 psi or more. In some embodiments, the polyurethane resin has a tensile strength of 6,000 psi or more. For example, the polyurethane resin has tensile strength of about 1,100 psi, about 1,200 psi, about 1,300 psi, about 1,400 psi, about 1,500 psi, about 1,600 psi, about 1700 psi, about 1,800 psi, about 1,900 psi, about 2,000 psi, about 2,100 psi, about 2,200 psi, about 2,300 psi, about 2,400 psi, about 2,500 psi, about 2,600 psi, about 2,700 psi, about 2,800 psi, about 2,900 psi, about 3,000 psi, about 3,100 psi, about 3,200 psi, about 3,300 psi, about 3,400 psi, about 3,500 psi, about 3,600 psi, about 3,700 psi, about 3,800 psi, about 3,900 psi, about 4,000 psi, about 4,100 psi, about 4,200 psi, about 4,300 psi, about 4,400 psi, about 4,500 psi, about 4,600 psi, about 4,700 psi, about 4,800 psi, about 4,900 psi, about 5,000 psi, about 5,100 psi, about 5,200 psi, about 5,300 psi, about 5,400 psi, about 5,500 psi, about 5,600 psi, about 5,700 psi, about 5,800 psi, about 5,900 psi, about 6,000 psi, about 6,100 psi, about 6,200 psi, about 6,300 psi, about 6,400 psi, about 6,500 psi, about 6,600 psi, about 6700 psi, about 6,800 psi, about 6,900 psi, or about 7,000 psi. In some embodiments, tensile strength of a polyurethane resin is assessed by ASTM D638.

In some embodiments, the polyurethane resin has an elongation at break of about 2% to about 300% or about 5% to 60%. For example, the polyurethane resin has an elongation at break of about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 55%, about 60%, about 65%, about 70%, about 75%, about 80%, about 85%, about 90%, about 95%, about 100%, about 110%, about 120%, about 130%, about 140%, about 150%, about 160%, about 170%, about 180%, about 190%, about 200%, about 210%, about 220%, about 230%, about 240%, about 250%, about 260%, about 270%, about 280%, about 290%, or about 300%. In some embodiments, elongation at break of a polyurethane resin is assessed by ASTM D638.

In some embodiments, the polyurethane resin has a flexural strength of about 2,000 psi to about 11,000 psi. For example, the polyurethane resin has a flexural strength of 2,000 psi or more, 2,500 psi or more, 3,000 psi or more, 3,500 psi or more, 4,000 psi or more, 4,500 psi or more, 5,000 psi or more, 5,500 psi or more, 6,000 psi or more, 6,500 psi or more, 7,000 psi or more, 7,500 psi or more, 8,000 psi or more, 8,500 psi or more, 9,000 psi or more, 9,500 psi or more, 10,000 psi or more, 10,500 psi or more, or 11,000 psi or more. In some embodiments, flexural strength of a polyurethane resin is assessed by ASTM D638.

In some embodiments, the polyurethane resin has a glass transition temperature (T_{g}) of about 5° C. to about 50° C., for example, 10° C. to 50° C., 15° C. to 50° C., 15° C. to 45° C., or 15° C. to 47° C., about 15° C., about 16° C., about 17° C., about 18° C., about 19° C., about 20° C., about 21° C., about 22° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C. In some embodiments, the T_{g} of a polyurethane resin is assessed by differential scanning calorimetry (DSC).

In some embodiments, the polyurethane resin has a Shore D hardness of 30 or more, 40 or more, 50 or more, 60 or more, 65 or more, 70 or more, 75 or more, or 80 or more. For example, a casted polyurethane resin can have a Shore D hardness of about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, or about 80. In some embodiments, Shore D hardness of a polyurethane resin is assessed by durometer hardness testing.

In some embodiments, the polyurethane resin has a break stress of about 1 MPa to about 40 MPa, about 5 MPa to about 35 MPa, or about 10 MPa to about 30 MPa. For example, a casted polyurethane resin can have a break stress of about 5 MPa, about 10 MPa, about 15 MPa, about 20 MPa, about 25 MPa, about 30 MPa, about 35 MPa, about 40 MPa, about 45 MPa, or about 50 MPa. In some embodiments, break stress of a polyurethane resin is assessed by ASTM D638.

In some embodiments, the polyurethane resin has a biobased content of about 50% to about 60% as assessed by ASTM 6866. For example, a polyurethane resin has a biobased content of at least 50%, at least 51%, at least 52%, at least 53%, at least 54%, at least 55%, at least 56%, at least 57%, at least 58%, at least 59%, or at least 60%. In some embodiments, a polyurethane resin has a biobased content of about 50%, about 51%, about 52%, about 53%, about 54%, about 55%, about 56%, about 57%, about 58%, about 59%, or about 60%.

In some embodiments, a sporting goods equipment or component thereof can be produced in a heated press at a temperature ranging from 50° C. to 100° C., from 50° C. to 60° C., from 60° C. to 70° C., from 70° C. to 80° C., from 80° C. to 90° C., or from 90° C. to 100° C., for example, at about 50° C., at about 60° C., at about 70° C., at about 80° C., at about 90° C., or at about 100° C.

In some embodiments, a sporting goods equipment or component thereof can be produced in a pressurized mold ranging from about 20 psi to about 100 psi, from about 20 psi to about 30 psi, from about 30 psi to about 40 psi, from about 40 psi to about 50 psi, from about 50 psi to about 60 psi, from about 60 psi to about 70 psi, or from about 80 psi to about 100 psi, for example, at about 20 psi, at about 30 psi, at about 40 psi, at about 50 psi, at about 60 psi, at about 70 psi, at about 80 psi, at about 90 psi, or at about 100 psi.

In some embodiments, a sporting goods equipment or component thereof can be produced by application of heat and/or pressure for duration of from about 10 minutes to about 20 minutes, from about 20 minutes to about 30 minutes, from about 30 minutes to about 40 minutes, from about 40 minutes to about 50 minutes, from about 50 minutes to about 70 minutes, for example, about 10 minutes, about 15 minutes, about 20 minutes, about 25 minutes, about 30 minutes, about 35 minutes, about 40 minutes, about 45 minutes, about 50 minutes, about 55 minutes, 60 minutes, about 65 minutes, about 70 minutes, about 75 minutes, about 80 minutes, 85 minutes, 90 minutes, or more.

Ski sidewalls can be constructed in various configurations including, for example, cap construction, sandwich construction, half cap construction, and hybrid construction. Cap construction is where the top layer folds over the edges of the core material. Cap construction can be a lightweighting method by the omission of heavy sidewall materials running along the length of the ski. Sandwich construction involves layering of the top sheets, core material, and bottom sheets such that the integrated product resembles a sandwich configuration. The core material is not covered by the top layers, but instead flanked on each side by a sidewall. In some embodiments, the sidewalls are beveled, for example top beveled. Sandwich construction can provide increased power transmission to the edge of the ski, and thus, greater flexibility. Half cap (hybrid) construction is a fusion of cap construction and sandwich construction. In this configuration, the top layer folds over the edges of the top half of the core material, including the sidewalls. The bottom half of the core material is uncovered, but flanked on each side by a sidewall. Half cap construction provides the benefit of lightweight and adequate power transmission.

Skis and other similar sporting goods equipment can have various shapes, contours, and profiles that confer specific functional properties. For example, the width and/or height can vary along the length of the ski. Straight lines skis, or skis having the same width along the length, are more stable, but can making turning more difficult. FIG. 1, Panel C illustrates an example algal polyurethane composite core outline. In this example, the tip and tail of the ski are wider than the waist (middle) of the ski, and the profile is rounded. FIG. 1, Panel D illustrates the outline overlaid onto a wood-algal PU core (top view). FIG. 1, Panel E illustrates a side view of the wood-algal PU foam cores shown in FIG. 1, Panels C and D.

The overall architecture of an example ski, including the sidewall material, is illustrated in FIG. 1, Panels F-H. The ski core material can have a variety of dimensions and configurations depending upon the precise needs of the designer. The ski core can also be composed of a variety of materials, including but not limited to, one or more wood species, a foam material, or a combination thereof. In some embodiments, the foam material is derived from microbial oils.

The precise order, length, and width of components of a composite material can be varied to suit the particular needs of the designer. In some embodiments, the composite material can have a length in centimeters (cm) of 50 cm to 250 cm, for example, about 50 cm, about 51 cm, about 52 cm, about 53 cm, about 54 cm, about 55 cm, about 56 cm, about 57 cm, about 58 cm, about 59 cm, about 60 cm, about 61 cm, about 62 cm, about 63 cm, about 64 cm, about 65 cm, about 66 cm, about 67 cm, about 68 cm, about 69 cm, about 70 cm, about 71 cm, about 72 cm, about 73 cm, about 74 cm, about 75 cm, about 76 cm, about 77 cm, about 78 cm, about 79 cm, about 80 cm, about 81 cm, about 82 cm, about 83 cm, about 84 cm, about 85 cm, about 86 cm, about 87 cm, about 88 cm, about 89 cm, about 90 cm, about 91 cm, about 92 cm, about 93 cm, about 94 cm, about 95 cm, about 96 cm, about 97 cm, about 98 cm, about 99 cm, about 100 cm, about 101 cm, about 102 cm, about 103 cm, about 104 cm, about 105 cm, about 106 cm, about 107 cm, about 108 cm, about 109 cm, about 110 cm, about 111 cm, about 112 cm, about 113 cm, about 114 cm, about 115 cm, about 116 cm, about 117 cm, about 118 cm, about 119 cm, about 120 cm, about 121 cm, about 122 cm, about 123 cm, about 124 cm, about 125 cm, about 126 cm, about 127 cm, about 128 cm, about 129 cm, about 130 cm, about 131 cm, about 132 cm, about 133 cm, about 134 cm, about 135 cm, about 136 cm, about 137 cm, about 138 cm, about 139 cm, about 140 cm, about 141 cm, about 142 cm, about 143 cm, about 144 cm, about 145 cm, about 146 cm, about 147 cm, about 148 cm, about 149 cm, about 150 cm, about 151 cm, about 152 cm, about 153 cm, about 154 cm, about 155 cm, about 156 cm, about 157 cm, about 158 cm, about 159 cm, about 160 cm, about 161 cm, about 162 cm, about 163 cm, about 164 cm, about 165 cm, about 166 cm, about 167 cm, about 168 cm, about 169 cm, about 170 cm, about 171 cm, about 172 cm, about 173 cm, about 174 cm, about 175 cm, about 176 cm, about 177 cm, about 178 cm, about 179 cm, about 180 cm, about 181 cm, about 182 cm, about 183 cm, about 184 cm, about 185 cm, about 186 cm, about 187 cm, about 188 cm, about 189 cm, about 190 cm, about 191 cm, about 192 cm, about 193 cm, about 194 cm, about 195 cm, about 196 cm, about 197 cm, about 198 cm, about 199 cm, about 200 cm, about 201 cm, about 202 cm, about 203 cm, about 204 cm, about 205 cm, about 206 cm, about 207 cm, about 208 cm, about 209 cm, about 210 cm, about 211 cm, about 212 cm, about 213 cm, about 214 cm, about 215 cm, about 216 cm, about 217 cm, about 218 cm, about 219 cm, about 220 cm, about 221 cm, about 222 cm, about 223 cm, about 224 cm, about 225 cm, about 226 cm, about 227 cm, about 228 cm, about 229 cm, about 230 cm, about 231 cm, about 232 cm, about 233 cm, about 234 cm, about 235 cm, about 236 cm, about 237 cm, about 238 cm, about 239 cm, about 240 cm, about 241 cm, about 242 cm, about 243 cm, about 244 cm, about 245 cm, about 246 cm, about 247 cm, about 248 cm, about 249 cm, or about 250 cm.

Each component or strip of the composite material can have a length of 50 cm to 250 cm, for example, about 50 cm, about 51 cm, about 52 cm, about 53 cm, about 54 cm, about 55 cm, about 56 cm, about 57 cm, about 58 cm, about 59 cm, about 60 cm, about 61 cm, about 62 cm, about 63 cm, about 64 cm, about 65 cm, about 66 cm, about 67 cm, about 68 cm, about 69 cm, about 70 cm, about 71 cm, about 72 cm, about 73 cm, about 74 cm, about 75 cm, about 76 cm, about 77 cm, about 78 cm, about 79 cm, about 80 cm, about 81 cm, about 82 cm, about 83 cm, about 84 cm, about 85 cm, about 86 cm, about 87 cm, about 88 cm, about 89 cm, about 90 cm, about 91 cm, about 92 cm, about 93 cm, about 94 cm, about 95 cm, about 96 cm, about 97 cm, about 98 cm, about 99 cm, about 100 cm, about 101 cm, about 102 cm, about 103 cm, about 104 cm, about 105 cm, about 106 cm, about 107 cm, about 108 cm, about 109 cm, about 110 cm, about 111 cm, about 112 cm, about 113 cm, about 114 cm, about 115 cm, about 116 cm, about 117 cm, about 118 cm, about 119 cm, about 120 cm, about 121 cm, about 122 cm, about 123 cm, about 124 cm, about 125 cm, about 126 cm, about 127 cm, about 128 cm, about 129 cm, about 130 cm, about 131 cm, about 132 cm, about 133 cm, about 134 cm, about 135 cm, about 136 cm, about 137 cm, about 138 cm, about 139 cm, about 140 cm, about 141 cm, about 142 cm, about 143 cm, about 144 cm, about 145 cm, about 146 cm, about 147 cm, about 148 cm, about 149 cm, about 150 cm, about 151 cm, about 152 cm, about 153 cm, about 154 cm, about 155 cm, about 156 cm, about 157 cm, about 158 cm, about 159 cm, about 160 cm, about 161 cm, about 162 cm, about 163 cm, about 164 cm, about 165 cm, about 166 cm, about 167 cm, about 168 cm, about 169 cm, about 170 cm, about 171 cm, about 172 cm, about 173 cm, about 174 cm, about 175 cm, about 176 cm, about 177 cm, about 178 cm, about 179 cm, about 180 cm, about 181 cm, about 182 cm, about 183 cm, about 184 cm, about 185 cm, about 186 cm, about 187 cm, about 188 cm, about 189 cm, about 190 cm, about 191 cm, about 192 cm, about 193 cm, about 194 cm, about 195 cm, about 196 cm, about 197 cm, about 198 cm, about 199 cm, about 200 cm, about 201 cm, about 202 cm, about 203 cm, about 204 cm, about 205 cm, about 206 cm, about 207 cm, about 208 cm, about 209 cm, about 210 cm, about 211 cm, about 212 cm, about 213 cm, about 214 cm, about 215 cm, about 216 cm, about 217 cm, about 218 cm, about 219 cm, about 220 cm, about 221 cm, about 222 cm, about 223 cm, about 224 cm, about 225 cm, about 226 cm, about 227 cm, about 228 cm, about 229 cm, about 230 cm, about 231 cm, about 232 cm, about 233 cm, about 234 cm, about 235 cm, about 236 cm, about 237 cm, about 238 cm, about 239 cm, about 240 cm, about 241 cm, about 242 cm, about 243 cm, about 244 cm, about 245 cm, about 246 cm, about 247 cm, about 248 cm, about 249 cm, or about 250 cm.

In some embodiments, the composite material can have a width of 5 cm to 20 cm, for example, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

Each component or strip of the composite material can have a width of 1 cm to 8 cm, for example, about 1 cm, about 1.5 cm, about 2 cm, about 2.5 cm, about 3 cm, about 3.5 cm, about 4 cm, about 4.5 cm, about 5 cm, about 5.5 cm, about 5 cm, about 6.5 cm, about 7 cm, about 7.5 cm, or about 8 cm.

In some embodiments, the composite material can have a height in millimeters (mm) of 1 mm to 20 mm, 16 mm to 20 mm, 20 mm to 25 mm, 25 mm to 30 mm, or 30 mm to 35 mm, for example, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm, about 26 mm, about 27 mm, about 28 mm, about 29 mm, about 30 mm, about 31 mm, about 32 mm, about 33 mm, about 34 mm, or about 35 mm.

Each component or strip of the composite material can have a height of 1 mm to 20 mm, for example, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm.

The composite material can be assembled in a mold. A mold can be heated, pressurized, or both. In some embodiments, a composite can be produced in a heated press at a temperature ranging from 50° C. to 100° C., from 50° C. to 60° C., from 60° C. to 70° C., from 70° C. to 80° C., from 80° C. to 90° C., or from 90° C. to 100° C., for example, at about 50° C., at about 60° C., at about 70° C., at about 80° C., at about 90° C., or at about 100° C.

In some embodiments, a composite material can be produced in a pressurized mold ranging from about 20 psi to about 100 psi, from about 20 psi to about 30 psi, from about 30 psi to about 40 psi, from about 40 psi to about 50 psi, from about 50 psi to about 60 psi, from about 60 psi to about 70 psi, or from about 80 psi to about 100 psi, for example, at about 20 psi, at about 30 psi, at about 40 psi, at about 50 psi, at about 60 psi, at about 70 psi, at about 80 psi, at about 90 psi, or at about 100 psi.

In some embodiments, a composite material can be produced by application of heat and/or pressure for duration of about 10 minutes, about 15 minutes, about 20 minutes, about 25 minutes, about 30 minutes, about 35 minutes, about 40 minutes, about 45 minutes, about 50 minutes, about 55 minutes, 60 minutes, about 65 minutes, about 70 minutes, about 75 minutes, about 80 minutes, 85 minutes, 90 minutes, or more.

Non-limiting examples of sporting goods equipment include, for example, a ski, an alpine ski, a touring ski, a cross country ski, an approach ski, a snowboard, a split board, a skateboard, a surfboard, a paddleboard, a wakeboard, a kiteboard, and a water ski.

The precise order, length, and width of components can be varied to confer desired properties of the final product (e.g., a sporting goods equipment). In some embodiments, the sporting goods equipment can have a length in centimeters (cm) of 50 cm to 250 cm, for example, about 50 cm, about 51 cm, about 52 cm, about 53 cm, about 54 cm, about 55 cm, about 56 cm, about 57 cm, about 58 cm, about 59 cm, about 60 cm, about 61 cm, about 62 cm, about 63 cm, about 64 cm, about 65 cm, about 66 cm, about 67 cm, about 68 cm, about 69 cm, about 70 cm, about 71 cm, about 72 cm, about 73 cm, about 74 cm, about 75 cm, about 76 cm, about 77 cm, about 78 cm, about 79 cm, about 80 cm, about 81 cm, about 82 cm, about 83 cm, about 84 cm, about 85 cm, about 86 cm, about 87 cm, about 88 cm, about 89 cm, about 90 cm, about 91 cm, about 92 cm, about 93 cm, about 94 cm, about 95 cm, about 96 cm, about 97 cm, about 98 cm, about 99 cm, about 100 cm, about 101 cm, about 102 cm, about 103 cm, about 104 cm, about 105 cm, about 106 cm, about 107 cm, about 108 cm, about 109 cm, about 110 cm, about 111 cm, about 112 cm, about 113 cm, about 114 cm, about 115 cm, about 116 cm, about 117 cm, about 118 cm, about 119 cm, about 120 cm, about 121 cm, about 122 cm, about 123 cm, about 124 cm, about 125 cm, about 126 cm, about 127 cm, about 128 cm, about 129 cm, about 130 cm, about 131 cm, about 132 cm, about 133 cm, about 134 cm, about 135 cm, about 136 cm, about 137 cm, about 138 cm, about 139 cm, about 140 cm, about 141 cm, about 142 cm, about 143 cm, about 144 cm, about 145 cm, about 146 cm, about 147 cm, about 148 cm, about 149 cm, about 150 cm, about 151 cm, about 152 cm, about 153 cm, about 154 cm, about 155 cm, about 156 cm, about 157 cm, about 158 cm, about 159 cm, about 160 cm, about 161 cm, about 162 cm, about 163 cm, about 164 cm, about 165 cm, about 166 cm, about 167 cm, about 168 cm, about 169 cm, about 170 cm, about 171 cm, about 172 cm, about 173 cm, about 174 cm, about 175 cm, about 176 cm, about 177 cm, about 178 cm, about 179 cm, about 180 cm, about 181 cm, about 182 cm, about 183 cm, about 184 cm, about 185 cm, about 186 cm, about 187 cm, about 188 cm, about 189 cm, about 190 cm, about 191 cm, about 192 cm, about 193 cm, about 194 cm, about 195 cm, about 196 cm, about 197 cm, about 198 cm, about 199 cm, about 200 cm, about 201 cm, about 202 cm, about 203 cm, about 204 cm, about 205 cm, about 206 cm, about 207 cm, about 208 cm, about 209 cm, about 210 cm, about 211 cm, about 212 cm, about 213 cm, about 214 cm, about 215 cm, about 216 cm, about 217 cm, about 218 cm, about 219 cm, about 220 cm, about 221 cm, about 222 cm, about 223 cm, about 224 cm, about 225 cm, about 226 cm, about 227 cm, about 228 cm, about 229 cm, about 230 cm, about 231 cm, about 232 cm, about 233 cm, about 234 cm, about 235 cm, about 236 cm, about 237 cm, about 238 cm, about 239 cm, about 240 cm, about 241 cm, about 242 cm, about 243 cm, about 244 cm, about 245 cm, about 246 cm, about 247 cm, about 248 cm, about 249 cm, or about 250 cm.

In some embodiments, the sporting goods equipment can have a width of 5 cm to 20 cm, for example, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm. A width can be a waist width, a tip width, or a tail width.

In some embodiments, the sporting goods equipment can have a height of 1 mm to 20 mm, for example, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, or about 20 mm. A height can be a waist height, a tip height, or a tail height.

In some embodiments, a ski described herein has a tip width, waist width, and tail width of 136 mm, 110 mm, and 128 mm, respectively. In some embodiments, a ski described herein has a length of 192 cm, 185 cm, 178 cm, or 171 cm.

In some embodiments, a ski described herein has a tip width, waist width, and tail width of 126 mm, 100 mm, and 119 mm, respectively. In some embodiments, a ski described herein has a length of 189 cm, 183 cm, 176 cm, 169 cm, or 162 cm.

In some embodiments, a ski described herein has a tip width, waist width, and tail width of 146 mm, 120 mm, and 143 mm, respectively. In some embodiments, a ski described herein has a length of 191 cm, 184 cm, 177 cm, or 170 cm.

### Polyurethane Production

Polyurethane can be produced by reacting isocyanates and polyols. Physical properties of polyurethanes can be influenced by the addition of chemical additives during processing. These physical properties include density, strength, and flexural properties, which are critical factors for the application of polyurethanes in consumer products. For example, PU foam production requires a blowing agent (also known as a pneumatogen), a substance that creates holes in the foam matrix, thereby providing cellular structure to the foam. Blowing agents can be added in a liquid form during the hardening stage of the foam resulting in the formation of gaseous products and byproducts. Non-limiting examples of chemical blowing agents include isocyanate, water, cyclopentane, pentane, methylformate, dimethoxymethane, azodicarbonamide, hydrazine, and other nitrogen-based materials, and sodium bicarbonate.

In contrast, the reaction of isocyanate and polyol in the absence of a blowing agent yields a polyurethane resin, which can be used as a pourable cast material.

### Polyols

Microbial oil produced by oleaginous microbes has numerous advantages, including, but not limited to, improved production efficiency and TAG compositions that can be enhanced for generating polyols. Namely, increasing the levels of unsaturation of TAG compositions can enhance control of the chemistry involved in the generation of polyols. These characteristics of microbial oil result in a greater yield of —OH functionality relative to other currently available oils with greater TAG heterogeneity (hence, lower purity) and/or diversity (e.g., oilseed or plant derived oils). Thus, polyols derived from a microbial oil can be preferable in generating polymers, including in instances where physical properties of a polymer can be compromised by molecular impurities, such as non-hydroxylated fatty acids, that may be present in oils comprising a more diverse and/or heterogeneous TAG profile.

Methods of producing triglyceride oils from oleaginous microbes may also have reduced carbon footprints than methods of producing oils from cultivation of oilseeds. This may be particularly true when the sugar used for the cultivation of these microbes is sourced from energy efficient sugar cane mills that significantly rely on power supplied from co-generation of sugarcane bagasse.

Polyols derived from a microbial oil may be particularly useful for producing polyurethane materials. For example, microbial oils may comprise relatively low TAG diversity, low fatty acid diversity, and the majority of fatty acids present in the microbial oil may be unsaturated fatty acids. A higher ratio of unsaturated fatty acid to saturated fatty acid allows for increased chemical reactivity at the double bonds. Microbial oils having low TAG diversity and a high proportion of unsaturated fatty acids are especially desirable in production of polyurethanes because hydroxylation of such a mixture yields a greater percentage of fatty acids that can participate in crosslinking reactions with isocyanates. Unlike unsaturated fatty acids, saturated fatty acids which do not contain carbon-carbon double bounds and cannot participate in crosslinking reactions with isocyanates. Thus, polyols generated from hydroxylation of unsaturated fatty acids from microbial oil may yield polyurethane materials having superior properties.

Polyols derived from highly unsaturated oils have high hydroxyl numbers compared to polyols derived from oils having lower saturation levels. High hydroxyl number increases the versatility of a polyol for producing a wide range of polyurethane materials. A polyol described herein can have a hydroxyl number of from 125 to 165, from 145 to 165, from 135 to 160, or from 140 to 155. For example, a polyol described herein can have a hydroxyl number of 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, or 165. In some embodiments, the hydroxyl number of a polyol can be determined by ASTM E1899.

In the process of producing natural oil polyols (NOPs) from natural sources, the hydroxyl functionality can be introduced via a chemical conversion of the triglyceride oil. This conversion requires the presence of a double bond on the acyl moiety of the fatty acid, e.g., an olefinic group, which can be accomplished using several different chemistries including, for example:

i) Epoxidation in the presence of hydrogen peroxide and an acid catalyst, followed by ring opening with reagents, such as water, hydrogen, methanol, ethanol, propanol, isopropanol, C₁-C₄ carboxylic acids, or other polyols, e.g., acetic acid or formic acid. Ring opening can be facilitated by reaction with an alcohol, including, for example, β-substituted alcohols. These chemistries result in secondary hydroxyl moieties, and are therefore less reactive, for example, with isocyanate or methyl esters.

ii) Ozonolysis by molecular oxygen results in the formation of ozonides, which upon further oxidation results in scission at the double bond and formation of di-acids, carboxylic acids, and upon reduction with hydrogen, formation of aldehydes. Ozonolysis and reduction of oleic acid, for example, produces azaleic acid, pelargonic acid, and pelargonaldehyde, respectively.

iii) Hydroformylation with synthesis gas (syngas), using rhodium or cobalt catalysts to form the aldehyde at the olefinic group, followed by reduction of the aldehyde to alcohol in the presence of hydrogen.

While typically carried out in organic solvent, processes that utilize aqueous systems have been developed to improve the sustainability of these chemistries. Of the chemistries described above, only hydroformylation results in the preservation of fatty acid length and formation of primary —OH moieties. Furthermore, only olefinic fatty acids with a double bond that is converted into a site possessing hydroxyl functionality, either through epoxidation and ring opening, ozonolysis and reduction, or hydroformylation and reduction, can participate in subsequent downstream chemistries, i.e., reaction with an isocyanate moiety to form a urethane linkage or reaction with methyl esters to form polyesters. All other fatty acids, namely, fully saturated fatty acids that do not contain carbon-carbon double bonds, cannot participate in crosslinking reactions with isocyanates. Hence, saturated fatty acids will compromise the structural integrity and degrade performance of the polymer produced therefrom.

The complexity and physical properties of a triglyceride oil can be evaluated by the fatty acid profile, and the triacylglycerol (TAG) profile. The fatty acid profile is simply a measure of fatty acid composition. The fatty acid profile of a triglyceride oil can be determined by subjecting oils to transesterification to generate fatty acid methyl esters and subsequently quantitating fatty acid type by Gas Chromatography with Flame Ionization Detector (GC-FID).

Additionally, if the fatty acid profile can be modulated such that the concentration of a particular species of monounsaturated or polyunsaturated fatty acids can be significantly increased from the concentration in the native oil, there would be an overall decrease in the diversity of TAG species present in the resulting oil. The net effect is that a higher number of hydroxylated fatty acids and a higher proportion of all TAG species can participate in urethane chemistries. For example, in two cultivars of peanut oil, N-3101 and H4110, oleic acid content was increased from 46% to 80% and total monounsaturated and polyunsaturated fatty acids was increased only subtly, from 77% to 84%, respectively. According to the TAG profile of the resulting oils derived from the two cultivars, approximately 95% of all TAG species are accounted for in just eight regioisomers in cultivar H4110 and 23 regioisomers in cultivar N-3101. Thus, triglycerides that are significantly enriched in a single species result in more homogeneous substrates for subsequent chemical manipulations and incorporation into materials.

Provided herein are methods for the conversion of oils into highly homogenous polyols via hydroformylation and hydrogenation, as well as epoxidation and ring opening. The molecular purity of these polyols can be advantageous for all types of polyurethane applications, including, but not limited to, as coatings for textiles and surfaces, as adhesives in packaging, textile, and industrial applications, as well as in hard and soft foam, and elastomeric applications.

### Microbial Oils

### Microbes

Microbial oils described herein may comprise novel triglycerides derived from a microbe. Microbial oils may be produced using oleaginous microbes.

Oleaginous microbes can refer to species of microbes having oil contents in excess of 20% on a dry cell weight basis. These microbes are uniquely suited for generating highly pure, natural oil polyols (NOPs) with hydroxyl (—OH) functionality. Oleaginous microbes have also been proven extremely facile for genetic modification and improvement.

Indeed, these improvements can occur on time scales that are greatly accelerated relative to what can be achieved in higher plant oilseeds. Oleaginous microbes offer tremendous utility in generating large quantities of triglyceride oils in short periods of time. In as little as 48 hours, appreciable oil production of about 30-40% oil (dry cell weight) can be obtained, whereas typical production requires 120 hours or more to achieve 70-80% oil (dry cell weight).

Furthermore, because these microbes can be heterotrophically grown using simple sugars, the production of these triglyceride oils can be divorced from the traditional constraints imposed by geography, climate, and season that constrain triglyceride oil production from oilseed crops.

Recombinant DNA techniques can be used to engineer or modify oleaginous microbes to produce triglyceride oils having desired fatty acid profiles and regiospecific or stereospecific profiles. Fatty acid biosynthetic genes, including, for example, those encoding stearoyl-ACP desaturase, delta-12 fatty acid desaturase, acyl-ACP thioesterase, ketoacyl-ACP synthase, and lysophosphatidic acid acyltransferase can be manipulated to increase or decrease expression levels and thereby biosynthetic activity. These genetically engineered microbes can produce oils having enhanced oxidative, or thermal stability, rendering a sustainable feedstock source for various chemical processes. The fatty acid profile of the oils can be enriched in midchain profiles or the oil can be enriched in triglycerides having specific saturation or unsaturation contents. WO2010/063031, WO2010/120923, WO2012/061647, WO2012/106560, WO2013/082186, WO2013/158938, WO2014/176515, WO2015/051319, and Lin et al. (2013) Bioengineered, 4:292-304, and Shi and Zhao. (2017) Front. Microbiol., 8: 2185 each discloses microbe genetic engineering techniques for oil production.

Among microalgae, several genera and species are particularly suitable for producing triglyceride oils that can be converted to polyols including, but not limited to, Chlorella sp., Pseudochlorella sp., Prototheca sp., Arthrospira sp., Euglena sp., Nannochloropsis sp. Phaeodactylum sp., Chlamydomonas sp., Scenedesmus sp., Ostreococcus sp., Selenastrum sp., Haematococcus sp., Nitzschia, Dunaliella, Navicula sp., Pseudotrebouxia sp., Heterochlorella sp., Trebouxia sp., Vavicula sp., Bracteococcus sp., Gomphonema sp., Watanabea sp., Botryococcus sp., Tetraselmis sp., and Isochrysis sp.

Among oleaginous yeasts, several genera are particularly suitable for producing triglyceride oils that can be converted to polyols including, but not limited to, Candida sp., Cryptococcus sp., Debaromyces sp., Endomycopsis sp., Geotrichum sp., Hyphopichia sp., Lipomyces sp., Pichia sp., Rodosporidium sp., Rhodotorula sp., Sporobolomyces sp., Starmerella sp., Torulaspora sp., Trichosporon sp., Wickerhamomyces sp., Yarrowia sp., and Zygoascus sp.

Among oleaginous bacteria there are several genera and species which are particularly suited to producing triglyceride oils that can be converted to polyols including, but not limited to Flavimonas oryzihabitans, Pseudomonas aeruginosa, Morococcus sp., Rhodobacter sphaeroides, Rhodococcus opacus, Rhodococcus erythropolis, Streptomyces jeddahensis, Ochrobactrum sp., Arthrobacter sp., Nocardia sp., Mycobacteria sp., Gordonia sp., Catenisphaera sp., and Dietzia sp.

### Growth of Oleaginous Microbes and Extraction of Microbial Oil

Oleaginous microbes may be cultivated in a bioreactor or fermenter. For example, heterotrophic oleaginous microbes can be cultivated on a sugar-containing nutrient broth.

Oleaginous microbes produce microbial oil, which comprises triacylglycerides or triacylglycerols and may be stored in storage bodies of the cell. A raw oil may be obtained from microbes by disrupting the cells and isolating the oil. WO2008/151149, WO2010/06032, WO2011/150410, WO2012/061647, and WO2012/106560 each discloses heterotrophic cultivation and oil isolation techniques. For example, microbial oil may be obtained by providing or cultivating, drying and pressing the cells. Microbial oils produced may be refined, bleached, and deodorized (RBD) as described in WO2010/120939, which is entirely incorporated herein by reference. Microbial oils can be obtained without further enrichment of one or more fatty acids or triglycerides with respect to other fatty acids or triglycerides in the raw oil composition.

### Microbial Oil Content

A microbial oil may be characterized by its triacylglycerol (“TAG”) profile. A TAG profile indicates relative amounts of various TAGs, and consequently fatty acids (each TAG molecule is a tri-ester of glycerol and three fatty acids), present in microbial oil. As disclosed herein, fatty acids from microbial oils having TAG profiles comprising high levels of unsaturated fatty acids and/or having low TAG diversity may be hydroformylated and hydrogenated to produce hydroformylated polyols.

A microbial oil may have a TAG profile comprising a high proportion of one or more unsaturated fatty acids relative to other fatty acids in the microbial oil. A microbial oil may have a TAG profile comprising 60% or more of one or more unsaturated fatty acids.

A microbial oil may have a TAG profile comprising a high proportion of one or more unsaturated fatty acids relative to one or more saturated fatty acids in the microbial oil. A microbial oil may have a TAG profile comprising low TAG diversity, e.g., fewer TAG species than in, for example, an oilseed oil. Microbial oils rich in a TAG or fatty acid may comprise fewer, different TAG species, or lesser amounts of different TAG species.

Oils derived from microorganisms having TAG profiles with high purity/high homogeneity/low diversity and high unsaturated fatty acid content are particularly advantageous for use in polyurethane production. Highly pure oils improve product yield and reduce the likelihood of contaminants that adversely affect the physical properties of the resulting polyurethane. Highly unsaturated oils allow for increased numbers of primary alcohol groups formed during hydroformylation and hydrogenation, thereby increasing the functionality, reactivity, and crosslinking during subsequent polymerization reactions. The quantity and type of crosslinking can influence the stability, durability, and rigidity of the resulting polymer.

In some embodiments, the microbial oil comprises up to nine, up to eight, up to seven, up to six, up to five, up to four, up to three, up to two, or one TAG species present in amounts of 1% or more of the total TAG species.

In some embodiments, the microbial oil comprises one TAG species present in amounts of about 85% or more, about 86% or more, about 87% or more, about 88% or more, about 89% or more, about 90% or more, about 91% or more, about 92% or more, about 93% or more, about 94% or more, about 95% or more, about 96% or more, about 97% or more, about 98% or more, or about 99% or more of the total TAG species.

In some embodiments, the microbial oil comprises two TAG species present in amounts of about 85% or more, about 86% or more, about 87% or more, about 88% or more, about 89% or more, about 90% or more, about 91% or more, about 92% or more, about 93% or more, about 94% or more, about 95% or more, about 96% or more, about 97% or more, about 98% or more, or about 99% or more of the total TAG species.

In some embodiments, the microbial oil comprises three TAG species present in amounts of about 85% or more, about 86% or more, about 87% or more, about 88% or more, about 89% or more, about 90% or more, about 91% or more, about 92% or more, about 93% or more, about 94% or more, about 95% or more, about 96% or more, about 97% or more, about 98% or more, or about 99% or more of the total TAG species.

Non-limiting examples of TAG species include OOO, LLL, LnLnLn, LLP, LPL, LnLnP, LnPLn, and any regioisomer thereof, wherein O is olein, L is linolein, Ln is linolenin, and P is palmitin. In some embodiments, the predominant TAG species in the microbial oil is OOO, LLL, LnLnLn, LLP, LPL, LnLnP, LnPLn, or any regioisomer thereof.

In some embodiments, the predominant TAG species in the microbial oil is OOO or triolein. In some embodiments, the microbial oil comprises at least about 60%, at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, or at least about 99% of triolein.

In some embodiments, the fatty acid profile of the microbial oil comprises at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of any one or combination of unsaturated fatty acid species.

Non-limiting examples of unsaturated fatty acid species include of a 16:1 fatty acid, a 16:2 fatty acid, a 16:3 fatty acid, an 18:1 fatty acid, an 18:2 fatty acid, an 18:3 fatty acid, an 18:4 fatty acid, a 20:1 fatty acid, a 20:2 fatty acid, a 20:3 fatty acid, a 22:1 fatty acid, a 22:2 fatty acid, a 22:3 fatty acid, a 24:1 fatty acid, a 24:2 fatty acid, and a 24:3 fatty acid.

In some embodiments, the fatty acid profile of an oil described herein comprises up to about 1%, up to about 2%, up to about 3%, up to about 4%, up to about 5%, up to about 6%, up to about 7%, up to about 8%, up to about 9%, up to about 10%, up to about 11%, least about 12%, up to about 13%, up to about 14%, up to about 15%, up to about 16%, up to about 17%, up to about 18%, up to about 19%, up to about 20%, up to about 21%, up to about 22%, up to about 23%, up to about 24%, up to about 25%, up to about 26%, up to about 27%, up to about 28%, up to about 29%, up to about 30%, up to about 31%, up to about 32%, up to about 33%, up to about 34%, or up to about 35% of any one or combination of saturated fatty acid species. Non-limiting examples of saturated fatty acid species include a 16:0 fatty acid, an 18:0 fatty acid, a 20:0 fatty acid, a 22:0 fatty acid, a 22:0 fatty acid, or a 24:0 fatty acid.

In some embodiments, the fatty acid profile of an oil described herein comprises about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of any one or combination of unsaturated fatty acid species. Non-limiting examples of unsaturated fatty acid species include a 16:1 fatty acid, a 16:2 fatty acid, a 16:3 fatty acid, an 18:1 fatty acid, an 18:2 fatty acid, an 18:3 fatty acid, an 18:4 fatty acid, a 20:1 fatty acid, a 20:2 fatty acid, a 20:3 fatty acid, a 22:1 fatty acid, a 22:2 fatty acid, a 22:3 fatty acid, a 24:1 fatty acid, a 24:2 fatty acid, and a 24:3 fatty acid.

In some embodiments, the fatty acid profile of an oil described herein comprises at least about 60%, at least about 61%, at least about 62%, at least about 63%, at least about 64%, at least about 65%, at least about 66%, at least about 67%, at least about 68%, at least about 69%, at least about 70%, least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of any one or combination of unsaturated fatty acid species. Non-limiting examples of unsaturated fatty acid species include those listed in TABLE 1.

In some embodiments, the fatty acid profile of an oil described herein comprises about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of any one or combination of unsaturated fatty acid species. Non-limiting examples of unsaturated fatty acid species include those listed in TABLE 1.

TABLE 1

| Monounsaturated | Lipid | Polyunsaturated | Lipid |
|---|---|---|---|
| FA | Number | FA | Number |
| Myristoleic acid | C14:1 | Hexadecatrienoic acid | C16:3 |
| | | (HTA) | |
| Palmitoleic acid | C16:1 | Linoleic acid | C18:2 |
| Sapienic acid | C16:1 | Linolelaidic acid | C18:2 |
| Oleic acid | C18:1 | α-Linolenic acid | C18:3 |
| Elaidic acid | C18:1 | Pinolenic acid | C18:3 |
| Vaccenic acid | C18:1 | Stearidonic acid | C18:4 |
| Petroselinic acid | C18:1 | Eicosadienoic acid | C20:2 |
| Eicosenoic | C20:1 | Mead acid | C20:3 |
| (Gondoic) acid | | | |
| Paullinic acid | C20:1 | Eicosatrienoic acid (ETE) | C20:3 |
| Gadoleic acid | C20:1 | Dihomo-γ-linolenic | C20:3 |
| | | acid (DGLA) | |
| Erucic acid | C22:1 | Podocarpic acid | C20:3 |
| Brassidic acid | C22:1 | Arachidonic acid (AA) | C20:4 |
| Nervonic acid | C24:1 | Eicosatetraenoic acid (ETA) | C20:4 |
| | | Eicosapentaenoic acid (EPA) | C20:5 |
| | | Heneicosapentaenoic acid | C21:5 |
| | | (HPA) | |
| | | Docosadienoic acid | C22:2 |
| | | Docosatetraenoic acid | C22:4 |
| | | (adrenic acid) | |
| | | Docosapentaenoic acid | C22:5 |
| | | (osbond acid) | |
| | | Docosapentaenoic acid (DPA) | C22:5 |
| | | Docosahexaenoic acid (DHA) | C22:6 |
| | | Tetracosatetraenoic acid | C24:4 |
| | | Tetracosapentaenoic acid | C24:5 |

In some embodiments, the fatty acid profile of a microbial oil described herein comprises at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of an 18:1 fatty acid.

In some embodiments, the fatty acid profile of a microbial oil described herein comprises about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of an 18:1 fatty acid.

In some embodiments, the fatty acid profile of a microbial oil described herein at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99% of oleic acid.

In some embodiments, the fatty acid profile of a microbial oil described herein comprises about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, or about 99% of oleic acid or oleate.

In some embodiments, the fatty acid profile a microbial oil described herein comprises up to about 1%, up to about 2%, up to about 3%, up to about 4%, up to about 5%, up to about 6%, up to about 7%, up to about 8%, up to about 9%, up to about 10%, up to about 11%, least about 12%, up to about 13%, up to about 14%, up to about 15%, up to about 16%, up to about 17%, up to about 18%, up to about 19%, up to about 20%, up to about 21%, up to about 22%, up to about 23%, up to about 24%, up to about 25%, up to about 26%, up to about 27%, up to about 28%, up to about 29%, up to about 30%, up to about 31%, up to about 32%, up to about 33%, up to about 34%, or up to about 35% of any one or combination of saturated fatty acid species selected from the group consisting of a 16:0 fatty acid, an 18:0 fatty acid, a 20:0 fatty acid, a 22:0 fatty acid, and a 24:0 fatty acid.

In some embodiments, a microbial oil comprises 60% or more of an 18:1 fatty acid and 30% or less of one or more saturated fatty acids. In some embodiments, the microbial oil comprises at least 85% oleate and up to 5% linoleate.

In some embodiments, a microbial oil comprises 60% or more of an 18:1 fatty acid, 30% or less of one or more saturated fatty acids, and at least one unsaturated fatty acid in a remainder. In some embodiments, the microbial oil comprises at least 85% oleate, up to 5% linoleate, and up to 1.8% palmitate.

In some embodiments, a microbial oil comprises at least 60% of an 18:1 fatty acid and up to 15% of one or more other unsaturated fatty acids selected from the group consisting of: a 16:1 fatty acid, an 18:2 fatty acid, an 18:3 fatty acid, and any combination thereof.

In some embodiments, a microbial oil comprises at least 60% of an 18:1 fatty acid, up to 10% of an 18:2 fatty acid, and up to 20% of a 16:0 fatty acid.

In some embodiments, a microbial oil comprises at least 70% of an 18:1 fatty acid, up to 8% of an 18:2 fatty acid, and up to 12% of a 16:0 fatty acid.

In some embodiments, a microbial oil comprises at least 80% of an 18:1 fatty acid, up to 8% of an 18:2 fatty acid, and up to 5% of a 16:0 fatty acid.

In some embodiments, a microbial oil has an iodine value of 88 g I₂/100 g.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a C18:1 content of at least 60%. Preferably, the isocyanate is MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 60%;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol is a TAG polyol with a hydroxyl number of 145 to 165. Preferably, the isocyanate is MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol is obtained by epoxidation and ring opening or hydroformylation and reduction of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a C18:1 content of at least 60%. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a hydroxyl number of 145 to 165;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol is obtained by epoxidation and ring opening or hydroformylation and reduction of a triglyceride oil. Preferably, the isocyanate is a polymeric MDI. Preferably, the catalyst is an amine catalyst or an organometallic catalyst. Preferably, the zeolite at an amount of about 5% on a weight-by-weight basis of the polyol. Preferably, the reaction mixture further comprises an alkyl diol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a hydroxyl number of 145 to 165, wherein the polyol is obtained by epoxidation and ring opening or hydroformylation and reduction of a triglyceride oil;
b) an isocyanate at an amount of about 25% to about 40% on a weight-by-weight basis of the reaction mixture,
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a C18:1 content of at least 80%. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 60%, wherein the polyol is obtained by epoxidation and ring opening or hydroformylation and reduction of a triglyceride oil;
b) an isocyanate at an amount of about 25% to about 40% on a weight-by-weight basis of the reaction mixture, wherein the isocyanate is a monomeric isocyanate or a polymeric isocyanate;
c) a catalyst at an amount of about 0.1% to about 1% on a weight-by-weight basis of the polyol, wherein the catalyst is an amine catalyst or an organometallic catalyst; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a hydroxyl number of 145 to 165. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 60%;
b) an isocyanate at an amount of about 25% to about 40% on a weight-by-weight basis of the reaction mixture, wherein the isocyanate is a monomeric isocyanate or a polymeric isocyanate;
c) a catalyst at an amount of about 0.1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a hydroxyl number of 145 to 165. Preferably, the isocyanate is a polymeric MDI. Preferably, the catalyst is an amine catalyst or an organometallic catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 60% and a hydroxyl number of 125 to 165, wherein the polyol is obtained by epoxidation and ring opening of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol;
   reacting the reaction mixture for a sufficient time, thereby producing the cast polyurethane resin. Preferably, the polyol is a biobased polyol. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the is obtained by epoxidation and ring opening of a triglyceride oil;
b) an isocyanate at an amount of about 25% to about 40% on a weight-by-weight basis of the reaction mixture, wherein the isocyanate is a polymeric isocyanate;
c) a catalyst at an amount of about 0.1% to about 1% on a weight-by-weight basis of the polyol, wherein the catalyst is an organometallic catalyst; and
d) a zeolite at an amount of about 0.1% to about 8% on a weight-by-weight basis of the polyol;
   reacting the reaction mixture for a sufficient time, thereby producing the cast polyurethane resin. Preferably, the polyol has a hydroxyl number of 145 to 165. Preferably, the isocyanate is a polymeric MDI. Preferably, the catalyst is DBTDL. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 60% and the polyol is obtained by epoxidation and ring opening of a triglyceride oil;
b) an isocyanate at an amount of about 25% to about 40% on a weight-by-weight basis of the reaction mixture, wherein the isocyanate is a polymeric isocyanate;
c) a catalyst at an amount of about 0.1% to about 1% on a weight-by-weight basis of the polyol;
d) a zeolite at an amount of about 0.1% to about 8% on a weight-by-weight basis of the polyol; and
e) an alkyl diol at an amount of about 0.1% to about 10% on a weight-by-weight basis of the polyol;
   reacting the reaction mixture for a sufficient time, thereby producing the cast polyurethane resin. Preferably, the polyol has a hydroxyl number of 145 to 165. Preferably, the isocyanate is a polymeric MDI. Preferably, the catalyst is DABCO. Preferably, the zeolite at an amount of about 5% on a weight-by-weight basis of the polyol. Preferably, the alkyl diol is 1,4-butanediol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 80% and the polyol is obtained by epoxidation and ring opening of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol;
d) a zeolite at an amount of about 0.1% to about 8% on a weight-by-weight basis of the polyol; and
e) 1,4-butanediol at an amount of about 0.1% to about 10% on a weight-by-weight basis of the polyol;
   reacting the reaction mixture for a sufficient time, thereby producing the cast polyurethane resin. Preferably, the polyol has a hydroxyl number of 145 to 165. Preferably, the isocyanate is a polymeric isocyanate. Preferably, the catalyst is an amine catalyst or an organometallic catalyst. Preferably, the zeolite at an amount of about 5% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 80% and a hydroxyl number of 145 to 165, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an organometallic catalyst;
d) a zeolite at an amount of about 0.1% to about 8% on a weight-by-weight basis of the polyol; and
e) 1,4-butanediol at an amount of about 0.1% to about 10% on a weight-by-weight basis of the polyol;
   reacting the reaction mixture for a sufficient time, thereby producing the cast polyurethane resin. Preferably, the polyol has a hydroxyl number of 145 to 165. Preferably, the polyol has a C18:1 content of at least 80%. Preferably, the catalyst is DBTDL and is at an amount of about 0.1% on a weight-by-weight basis of the polyol. Preferably, the zeolite at an amount of about 5% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 65% on a weight-by-weight basis of the reaction mixture, wherein the polyol has a C18:1 content of at least 80% and a hydroxyl number of about 140 to about 155, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an organometallic catalyst;
d) a zeolite at an amount of about 5% on a weight-by-weight basis of the polyol; and
e) 1,4-butanediol at an amount of about 5% to about 10% on a weight-by-weight basis of the polyol;
   reacting the reaction mixture for a sufficient time, thereby producing the cast polyurethane resin. Preferably, the polyol has a hydroxyl number of 140 to 150. Preferably, the polyol has a C18:1 content of at least 80%. Preferably, the catalyst is DBTDL and is at an amount of about 0.1% on a weight-by-weight basis of the polyol. Preferably, the zeolite at an amount of about 5% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 75% on a weight-by-weight basis of the reaction mixture, wherein the polyol has a C18:1 content of at least 80% and a hydroxyl number of 135 to 160, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an amine catalyst;
d) a zeolite at an amount of about 0.1% to about 8% on a weight-by-weight basis of the polyol; and
e) 1,4-butanediol at an amount of about 0.1% to about 10% on a weight-by-weight basis of the polyol;
   reacting the reaction mixture for a sufficient time, thereby producing the cast polyurethane resin. Preferably, the polyol has a hydroxyl number of 140 to 155. Preferably, the polyol has a C18:1 content of at least 80%. Preferably, the catalyst is DABCO and is at an amount of about 0.8% on a weight-by-weight basis of the polyol. Preferably, the zeolite at an amount of about 5% on a weight-by-weight basis of the polyol.

In some aspects, the present disclosure provides a method for producing a cast polyurethane resin, wherein the method comprising preparing a reaction mixture that comprises:
a) a polyol at an amount of about 50% to about 65% on a weight-by-weight basis of the reaction mixture, wherein the polyol has a C18:1 content of at least 80% and a hydroxyl number of about 140 to about 155, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI or a monomeric MDI;
c) a catalyst at an amount of about 0.1% to about 1% on a weight-by-weight basis of the polyol, wherein the catalyst is an amine catalyst;
d) a zeolite at an amount of about 5% on a weight-by-weight basis of the polyol; and
e) 1,4-butanediol at an amount of about 5% to about 10% on a weight-by-weight basis of the polyol;
   reacting the reaction mixture for a sufficient time, thereby producing the cast polyurethane resin. Preferably, the polyol has a hydroxyl number of 140 to 150. Preferably, the polyol has a C18:1 content of at least 80%. Preferably, the catalyst is DABCO and is at an amount of about 0.8% on a weight-by-weight basis of the polyol. Preferably, the zeolite at an amount of about 5% on a weight-by-weight basis of the polyol.

In some aspects, the present disclosure provides a reaction mixture comprising:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol has a C18:1 content of at least 60%. Preferably, the amine is a polymeric isocyanate. Preferably, the catalyst is an organometallic catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 60%;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol is a TAG polyol with a hydroxyl number of 140 to 155. Preferably, the isocyanate is a polymeric isocyanate. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol is obtained by epoxidation and ring opening or hydroformylation and reduction of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol has a C18:1 content of at least 60%. Preferably, the isocyanate is a polymeric isocyanate. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a hydroxyl number of 140 to 155;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol is obtained by epoxidation and ring opening or hydroformylation and reduction of a triglyceride oil. Preferably, the isocyanate is a polymeric MDI. Preferably, the catalyst is an amine catalyst or an organometallic catalyst. Preferably, the zeolite at an amount of about 5% on a weight-by-weight basis of the polyol. Preferably, the reaction mixture further comprises an alkyl diol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a hydroxyl number of 140 to 155, wherein the polyol is obtained by epoxidation and ring opening or hydroformylation and reduction of a triglyceride oil;
b) an isocyanate at an amount of about 25% to about 40% on a weight-by-weight basis of the reaction mixture,
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol has a C18:1 content of at least 80%. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 60%, wherein the polyol is obtained by epoxidation and ring opening or hydroformylation and reduction of a triglyceride oil;
b) an isocyanate at an amount of about 25% to about 40% on a weight-by-weight basis of the reaction mixture, wherein the isocyanate is a monomeric isocyanate or a polymeric isocyanate;
c) a catalyst at an amount of about 0.1% to about 1% on a weight-by-weight basis of the polyol, wherein the catalyst is an amine catalyst or an organometallic catalyst; and
d) a zeolite at an amount of about 0.1% to about 8% on a weight-by-weight basis of the polyol.
   Preferably, the polyol has a hydroxyl number of 140 to 155. Preferably, the isocyanate is a polymeric MDI. Preferably, the catalyst is an organometallic catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 60%;
b) an isocyanate at an amount of about 25% to about 40% on a weight-by-weight basis of the reaction mixture, wherein the isocyanate is a monomeric isocyanate or a polymeric isocyanate;
c) a catalyst at an amount of about 0.1% on a weight-by-weight basis of the polyol; and
d) a zeolite at an amount of about 0.1% to about 8% on a weight-by-weight basis of the polyol.
   Preferably, the polyol has a hydroxyl number of 140 to 155. Preferably, the isocyanate is a polymeric MDI. Preferably, the catalyst is an amine catalyst or an organometallic catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 60% and a hydroxyl number of 125 to 165, wherein the polyol is obtained by epoxidation and ring opening of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.
   Preferably, the polyol is a biobased polyol. Preferably, the isocyanate is a polymeric MDI. Preferably, the catalyst is an amine catalyst. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the is obtained by epoxidation and ring opening of a triglyceride oil;
b) an isocyanate at an amount of about 25% to about 40% on a weight-by-weight basis of the reaction mixture, wherein the isocyanate is a polymeric isocyanate;
c) a catalyst at an amount of about 0.1% to about 1% on a weight-by-weight basis of the polyol, wherein the catalyst is an organometallic catalyst; and
d) a zeolite at an amount of about 0.1% to about 8% on a weight-by-weight basis of the polyol.
   Preferably, the polyol has a hydroxyl number of 140 to 155. Preferably, the isocyanate is a polymeric MDI. Preferably, the catalyst is DBTDL. Preferably, the zeolite at an amount of about 5% on a weight-by-weight basis of the polyol. Preferably, the reaction mixture further comprises 1,4-butanediol at an amount of about 1% to about 10% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 60% and the polyol is obtained by epoxidation and ring opening of a triglyceride oil;
b) an isocyanate at an amount of about 25% to about 40% on a weight-by-weight basis of the reaction mixture, wherein the isocyanate is a polymeric isocyanate;
c) a catalyst at an amount of about 0.1% to about 1% on a weight-by-weight basis of the polyol;
d) a zeolite at an amount of about 0.1% to about 8% on a weight-by-weight basis of the polyol; and
e) an alkyl diol at an amount of about 0.1% to about 10% on a weight-by-weight basis of the polyol.
   Preferably, the polyol has a hydroxyl number of 140 to 155. Preferably, the isocyanate is a polymeric MDI. Preferably, the catalyst is an amine catalyst or an organometallic catalyst. Preferably, the zeolite at an amount of about 5% on a weight-by-weight basis of the polyol. Preferably, the alkyl diol is 1,4-butanediol.

In some aspects, the present disclosure provides a reaction mixture comprising:
a) a polyol at an amount of about 50% to about 75% on a weight-by-weight basis of the reaction mixture, wherein the polyol has a C18:1 content of at least 80% and the polyol is obtained by epoxidation and ring opening of a triglyceride oil;
b) an isocyanate at an amount of about 25% to about 40% on a weight-by-weight basis of the reaction mixture;
c) a catalyst at an amount of about 0.1% to about 1% on a weight-by-weight basis of the polyol;
d) a zeolite at an amount of about 0.1% to about 8% on a weight-by-weight basis of the polyol; and
e) 1,4-butanediol at an amount of about 0.1% to about 10% on a weight-by-weight basis of the polyol.
   Preferably, the polyol has a hydroxyl number of 140 to 155. Preferably, the isocyanate is a polymeric isocyanate. Preferably, the catalyst is an amine catalyst. Preferably, the zeolite at an amount of about 5% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 80% and a hydroxyl number of 135 to 160, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an organometallic catalyst;
d) a zeolite at an amount of about 0.1% to about 8% on a weight-by-weight basis of the polyol; and
e) 1,4-butanediol at an amount of about 0.1% to about 10% on a weight-by-weight basis of the polyol.
   Preferably, the polyol has a hydroxyl number of 140 to 155. Preferably, the polyol has a C18:1 content of at least 80%. Preferably, the catalyst is DBTDL and is at an amount of about 0.1% on a weight-by-weight basis of the polyol. Preferably, the zeolite at an amount of about 5% on a weight-by-weight basis of the polyol.

In some aspects, the present disclosure provides a reaction mixture comprising:
a) a polyol at an amount of about 50% to about 65% on a weight-by-weight basis of the reaction mixture, wherein the polyol has a C18:1 content of at least 80% and a hydroxyl number of about 140 to about 155, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an organometallic catalyst;
d) a zeolite at an amount of about 5% on a weight-by-weight basis of the polyol; and
e) 1,4-butanediol at an amount of about 5% to about 10% on a weight-by-weight basis of the polyol.
   Preferably, the polyol has a hydroxyl number of 140 to 150. Preferably, the polyol has a C18:1 content of at least 80%. Preferably, the catalyst is DBTDL and is at an amount of about 0.1% on a weight-by-weight basis of the polyol. Preferably, the zeolite at an amount of about 5% on a weight-by-weight basis of the polyol.

In some aspects, the present disclosure provides a reaction mixture comprising:
a) a polyol at an amount of about 50% to about 75% on a weight-by-weight basis of the reaction mixture, wherein the polyol has a C18:1 content of at least 80% and a hydroxyl number of 135 to 160, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI;
c) a catalyst at an amount of about 0.1% to about 1% on a weight-by-weight basis of the polyol, wherein the catalyst is an amine catalyst;
d) a zeolite at an amount of about 0.1% to about 8% on a weight-by-weight basis of the polyol; and
e) 1,4-butanediol at an amount of about 0.1% to about 10% on a weight-by-weight basis of the polyol.
   Preferably, the polyol has a hydroxyl number of 140 to 155. Preferably, the polyol has a C18:1 content of at least 80%. Preferably, the catalyst is DABCO and is at an amount of about 0.8% on a weight-by-weight basis of the polyol. Preferably, the zeolite at an amount of about 5% on a weight-by-weight basis of the polyol.

In some aspects, the present disclosure provides a reaction mixture comprising:
a) a polyol at an amount of about 50% to about 65% on a weight-by-weight basis of the reaction mixture, wherein the polyol has a C18:1 content of at least 80% and a hydroxyl number of about 140 to about 155, wherein the polyol is obtained by epoxidation and ring opening of a triglyceride oil;
b) an isocyanate at an amount of about 30% to about 40% on a weight-by-weight basis of the reaction mixture, wherein the isocyanate is a polymeric MDI or a monomeric MDI;
c) a catalyst at an amount of about 0.1% to about 1% on a weight-by-weight basis of the polyol, wherein the catalyst is an amine catalyst;
d) a zeolite at an amount of about 5% on a weight-by-weight basis of the polyol; and
e) 1,4-butanediol at an amount of about 5% to about 10% on a weight-by-weight basis of the polyol.
   Preferably, the polyol has a hydroxyl number of 140 to 150. Preferably, the polyol has a C18:1 content of at least 80%. Preferably, the catalyst is DABCO and is at an amount of about 0.8% on a weight-by-weight basis of the polyol. Preferably, the zeolite at an amount of about 5% on a weight-by-weight basis of the polyol.

In some embodiments of the reaction mixture aspects above, the polyol is a biobased polyol. In some embodiments, the polyol is TAG polyol. In some embodiments of the reaction mixture aspects above, the polyol is at an amount of about 54% to about 72% on a weight-by-weight basis of the reaction mixture. In some embodiments of the reaction mixture aspects above, the polyol has a C18:1 content of at least 60%. In some embodiments of the reaction mixture aspects above, the polyol has a C18:1 content of at least 80%. In some embodiments of the reaction mixture aspects above, the polyol has a C18:1 content of at least 90%. In some embodiments of the reaction mixture aspects above, the polyol is a TAG polyol with a hydroxyl number of 125 to 165. In some embodiments of the reaction mixture aspects above, the polyol is a TAG polyol with a hydroxyl number of 135 to 160. In some embodiments of the reaction mixture aspects above, the polyol is a TAG polyol with a hydroxyl number of 145 to 165. In some embodiments of the reaction mixture aspects above, the polyol is a TAG polyol with a hydroxyl number of 140 to 155. In some embodiments of the reaction mixture aspects above, the polyol is a TAG polyol with a hydroxyl number of 149. In some embodiments of the reaction mixture aspects above, the polyol is obtained by epoxidation and ring opening or hydroformylation and reduction of a triglyceride oil. In some embodiments of the reaction mixture aspects above, the polyol is obtained by epoxidation and ring opening of a triglyceride oil. In some embodiments of the reaction mixture aspects above, the polyol is obtained by hydroformylation and reduction of a triglyceride oil.

In some embodiments of the reaction mixture aspects above, the isocyanate is at an amount of about 28% to about 38% on a weight-by-weight basis of the reaction mixture. In some embodiments of the reaction mixture aspects above, the isocyanate is a monomeric isocyanate. In some embodiments of the reaction mixture aspects above, the isocyanate is a polymeric isocyanate. In some embodiments of the reaction mixture aspects above, the isocyanate is methylene diphenyl diisocyanate (MDI). In some embodiments of the reaction mixture aspects above, the isocyanate is polymeric methylene diphenyl diisocyanate (MDI).

In some embodiments of the reaction mixture aspects above, the catalyst is at an amount of about 0.1% to about 0.5% on a weight-by-weight basis of the polyol. In some embodiments of the reaction mixture aspects above, the catalyst is at an amount of about 0.1% on a weight-by-weight basis of the polyol. In some embodiments of the reaction mixture aspects above, the catalyst is at an amount of about 0.5% to about 0.8% on a weight-by-weight basis of the polyol. In some embodiments of the reaction mixture aspects above, the catalyst is at an amount of about 0.8% on a weight-by-weight basis of the polyol. In some embodiments of the reaction mixture aspects above, the catalyst is an amine catalyst. In some embodiments of the reaction mixture aspects above, the amine catalyst is a primary amine catalyst, a secondary amine catalyst, or a tertiary primary amine catalyst. In some embodiments of the reaction mixture aspects above, the catalyst is DABCO. In some embodiments of the reaction mixture aspects above, the catalyst is an organometallic catalyst. In some embodiments of the reaction mixture aspects above, the organometallic catalyst is an organotin catalyst, an organozinc catalyst, or an organozirconium catalyst. In some embodiments of the reaction mixture aspects above, the catalyst is an organotin catalyst. In some embodiments of the reaction mixture aspects above, the catalyst is DBTDL. In some embodiments of the reaction mixture aspects above, the catalyst is DABCO and is at an amount of about 0.8% on a weight-by-weight basis of the polyol. In some embodiments of the reaction mixture aspects above, the catalyst is DBTDL and is at an amount of about 0.1% on a weight-by-weight basis of the polyol.

In some embodiments of the reaction mixture aspects above, the zeolite at an amount of about 0.1% to about 5% on a weight-by-weight basis of the polyol. In some embodiments of the reaction mixture aspects above, the zeolite is at an amount of about 1.25% on a weight-by-weight basis of the polyol. In some embodiments of the reaction mixture aspects above, the zeolite at an amount of about 5% on a weight-by-weight basis of the polyol.

In some embodiments of the reaction mixture aspects above, the reaction mixture further comprises an alkyl diol. In some embodiments of the reaction mixture aspects above, the alkyl diol is at an amount of about 0.1% to about 10% on a weight-by-weight basis of the polyol. In some embodiments of the reaction mixture aspects above, the alkyl diol is at an amount of about 1% to about 5% on a weight-by-weight basis of the polyol. In some embodiments of the reaction mixture aspects above, the alkyl diol is 1,4-butanediol. In some embodiments of the reaction mixture aspects above, the 1,4-butanediol is at an amount of about 1% to about 5% on a weight-by-weight basis of the polyol. In some embodiments of the reaction mixture aspects above, the 1,4-butanediol is at an amount of about 3% on a weight-by-weight basis of the polyol. In some embodiments of the reaction mixture aspects above, the 1,4-butanediol is at an amount of about 5% on a weight-by-weight basis of the polyol. In some embodiments of the reaction mixture aspects above, the 1,4-butanediol is at an amount of about 7% on a weight-by-weight basis of the polyol. In some embodiments of the reaction mixture aspects above, the 1,4-butanediol is at an amount of about 10% on a weight-by-weight basis of the polyol.

In some embodiments of the reaction mixture aspects above, the method further comprises curing the polyol, the isocyanate, the zeolite, and the catalyst at room temperature for at least 48 hours. In some embodiments of the reaction mixture aspects above, the method further comprises curing the polyol, the isocyanate, the zeolite, and the catalyst at 110° C. for about 15 hours.

In some embodiments of the reaction mixture aspects above, the cast polyurethane resin has a biobased content is at least about 50% as assessed by ASTM 6866. In some embodiments of the reaction mixture aspects above, the cast polyurethane resin has a biobased content is about 50% to about 60% as assessed by ASTM 6866. In some embodiments of the reaction mixture aspects above, the cast polyurethane resin has a biobased content is about 58% as assessed by ASTM 6866.

In some embodiments of the reaction mixture aspects above, the cast polyurethane resin has a glass transition temperature of at least 5° C. In some embodiments of the reaction mixture aspects above, the cast polyurethane resin has a glass transition temperature of about 5° C. to about 50° C.

In some embodiments of the reaction mixture aspects above, the cast polyurethane resin has a Shore D hardness of at least 50 as assessed by durometer testing.

In some embodiments of the reaction mixture aspects above, the cast polyurethane resin has a tensile strength of at least 500 psi as assessed by ASTM D638.

In some embodiments of the reaction mixture aspects above, the cast polyurethane resin has an elongation at break of at least 5% as assessed by ASTM D638.

In some embodiments of the reaction mixture aspects above, the cast polyurethane resin has a flexural strength of at least 2,000 psi.

In some embodiments of the reaction mixture aspects above, the cast polyurethane resin has break stress of at least 3 MPa.

In some aspects, the present disclosure provides a method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin and a zeolite at an amount of about 0.1% to about 8% on a weight-by-weight basis of the polyol in the presence of a catalyst at an amount of about 0.1% to about 0.8% on a weight-by-weight basis of the polyol, thereby preparing the cast polyurethane resin.

In some aspects, the present disclosure provides a method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin and a zeolite at an amount of about 0.1% to about 8% on a weight-by-weight basis of the polyol in the presence of a catalyst at an amount of about 0.1% to about 0.8% on a weight-by-weight basis of the polyol, thereby preparing the cast polyurethane resin, wherein the polyol has a C18:1 content of at least 80% and a hydroxyl number of 149, wherein the polyol is obtained by epoxidation and ring opening of a triglyceride oil.

In some aspects, the present disclosure provides a method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin, a zeolite at an amount of about 0.1% to about 8% on a weight-by-weight basis of the polyol, and an alkyl diol at an amount of about 0.1% to about 10% on a weight-by-weight basis of the polyol in the presence of a catalyst at an amount of about 0.1% to about 0.8% on a weight-by-weight basis of the polyol, thereby preparing the cast polyurethane resin.

In some aspects, the present disclosure provides a method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin, a zeolite at an amount of about 0.1% to about 8% on a weight-by-weight basis of the polyol, and 1,4-butanediol at an amount of about 0.1% to about 10% on a weight-by-weight basis of the polyol in the presence of a catalyst at an amount of about 0.1% to about 0.8% on a weight-by-weight basis of the polyol, thereby preparing the cast polyurethane resin, wherein the polyol has a C18:1 content of at least 80% and a hydroxyl number of 149, wherein the polyol is obtained by epoxidation and ring opening of a triglyceride oil.

In some aspects, the present disclosure provides a cast polyurethane resin produced by any one of the methods described herein. In further aspects, the present disclosure provides a cast polyurethane resin produced from any one of the reaction mixtures described herein. In further aspects, the present disclosure provides a cast polyurethane resin produced by reacting components of any one of the reaction mixtures described herein in a vessel.

### EXAMPLES

### Example 1. An Example Ski with Sidewalls Composed of Polyurethane Derived from Microbial Oil

FIG. 1, Panel A illustrates a top view of an example algal polyurethane composite core. The core composite is comprised of alternating layers of algal derived PU and wood, which can vary in configuration and dimension. Configuration and dimensions of the composite can be optimized to confer specific structural and functional properties in the finished product.

FIG. 1, Panel B illustrates a cross-sectional view of Panel A. In this example, wood and algal PU foam cores are milled to height of 16 mm. Wood strips are 25-30 mm wide, depending upon their precise location, while algal PU foam strips are 15 mm wide. The specific orientation and geometry of wood or algal foam material used can be optimized depending upon the desired performance characteristics one is trying to achieve.

Example dimensions are shown in centimeters (cm). The example composite includes seven laminated layers: two layers of algal polyurethane (a), followed by a layer of wood (b), followed by a polyurethane core (a′), a second layer of wood, and two additional layers of polyurethane. Each of the layers are affixed together lengthwise.

### Example 2. A Quick Cure Cast Urethane Formulation

A cast urethane formulation comprised of a B-side (polyol) chemistry including 53% wt/wt algal oil polyol (epoxidized algal oil polyol, EAOP), 5% wt/wt 1,4-butanediol, 1.25% wt/wt zeolites, and 0.8% wt/wt catalyst (DABCO; triethylene diamine). Each of the amounts of the 1,4-butanediol, zeolites, and catalyst used was relative to the polyol components in the B-side chemistry. The A-side chemistry comprised of the isocyanate (polymeric MDI).

Although DABCO catalyst (triethylene diamine) was used herein, other suitable primary or secondary amine catalysts, such as 2,2′-oxybis(N,N-dimethylethylamine), organotin, organozinc, or organozirconium catalysts can be used.

Although polymeric MDI was used herein, other suitable isocyanates, including pure, monomeric MDI, such as Rubinate® 44 and Rubinate® 9225, for example.

The zeolites were either UOP L paste or powder containing potassium calcium sodium aluminosilicates of zeolite A type (ca. 3 Å pore size). If powder was used, the powder was mixed with the EAOP at a ratio of 1:1 wt/wt. The paste was supplied 1:1 with castor oil.

The formulation components were mixed vigorously by hand and aliquoted to a handheld dispensing gun equipped with a static mixing tip. The mixture was then cast into a mold having dimensions of 17.3 cm (L)×17.3 cm (W)×1 cm (D) and allowed to cure at room temperature (about 23° C.).

After one hour, the cast was removed from the mold. Using a computer numerical control (CNC) router, 5 dog bone shaped coupons (186 mm long, 23 mm grip length, 128 mm gage length, 8 mm wide, 8.2 mm thick) were prepared for tensile testing according to ASTM D638.

The coupons were also machined to bars having the dimensions of 8.2 mm wide×8.0 mm thick×140 mm long for three-point bend testing. The test was carried out at a span of 110 mm with a cross head rate of 22.4 mm/min.

The machined coupons were designated as quick cure (QC) cast urethanes and either tested at ambient temperature (23° C.), or by pre-chilling overnight at −20° C. and placing in a plastic bag on ice prior to low temperature (LT) testing (0-2° C. as assessed by IR gun).

FIG. 2, Panel A shows the results (stress strain curves) of tensile strength testing of QC cast urethanes according to ASTM D638 at room temperature (RT), while FIG. 2, Panel B shows the results at 0-2° C. (LT).

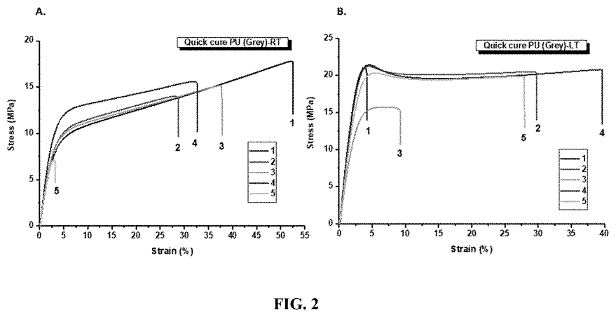

FIG. 3, Panel A shows the results of three-point bend testing of QC cast urethanes at RT. FIG. 3, Panel B shows the corresponding results at 0-2° C. (LT).

Coupons used for three-point bend testing were also subjected to durometer testing to assess the hardness of the materials. Results of these tests are shown in TABLE 2.

TABLE 2
Shore D Hardness of QC Cast PU

| | |
|---|---|
| Replicates | 6 |
| Average | 65 |
| STDEV | 3 |

### Example 3. A Slow Cure Cast Urethane Formulation

A second cast urethane formulation was prepared as described in Example 2 except that the catalyst loading was 0.1% (wt/wt) relative to the polyol components. The formulation components were mixed vigorously by hand and aliquoted to a handheld dispensing gun equipped with a static mixing tip. The mixture was then cast into a mold having dimensions of 17.3 cm (L)×17.3 cm (W)×1 cm (D) and allowed to cure at room temperature (about 23° C.).

After 24 hours, the cast was removed from the mold. Using a CNC router, 5 dog bone shaped coupons (186 mm long, 23 mm grip length, 128 mm gage length, 8 mm wide, 8.2 mm thick) were prepared for tensile testing according to ASTM D638.

The coupons were also machined to bars having dimensions of 8.2 mm wide×8.0 mm thick×140 mm long for three-point bend testing. The test was carried out at a span of 110 mm with a cross head rate of 22.4 mm/min.

The machined coupons as above, were designated as slow cure (SC) cast urethanes and either tested at ambient temperature (23° C.) or by pre-chilling overnight at −20° C., and placing in a plastic bag on ice prior to LT testing (0-2° C. as assessed by IR gun).

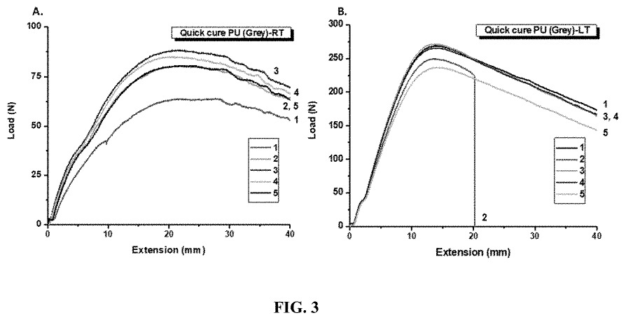

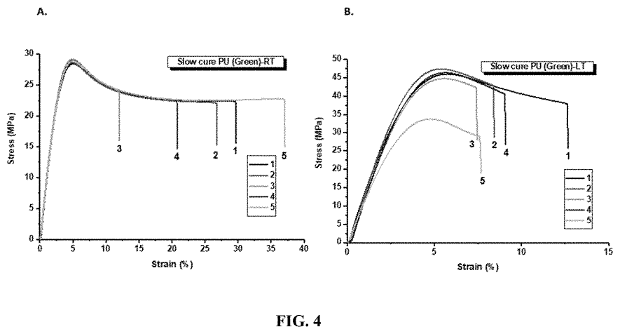

FIG. 4, Panel A shows the results (stress strain curves) of tensile strength testing of SC cast urethanes according to ASTM D638 at RT, while FIG. 4, Panel B shows the results at 0-2° C. (LT).

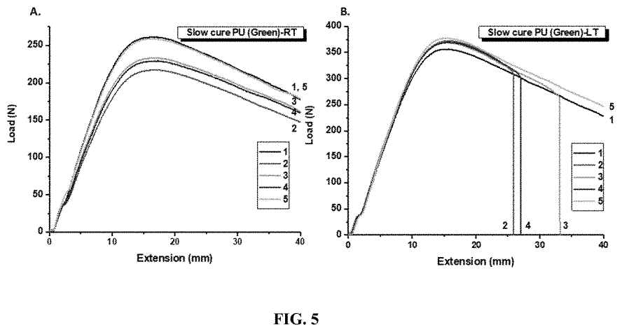

FIG. 5, Panel A shows the results of three-point bend testing of SC cast urethanes at RT. FIG. 5, Panel B shows the corresponding results at 0-2° C. (LT).

Coupons used for three-point bend testing were also subjected to durometer testing to assess the hardness of the materials. Results of these tests are shown in TABLE 3.

TABLE 3
Shore D Hardness of SC Cast PU

| | |
|---|---|
| Replicates | 6 |
| Average | 77 |
| STDEV | 1 |

The algal polyol based cast urethanes described here, whether produced by quick cure or slow cure, showed improved physical properties at lower temperatures, both in terms of tensile strength as well as three-point bend testing. Furthermore, the slow cure formulation showed enhanced physical properties relative to the quick cure formulation at both RT and LT conditions. These improved performance characteristics at lower temperatures are relevant to end use applications in winter sports equipment.

### Example 4. A Two Component Liquid Casting Resin Kit

A liquid casting resin kit comprising a resin component (containing isocyanate; A-side chemistry) and a hardener component (polyol; B-side chemistry) was prepared according the formulations described in Examples 2 and 3. The kit was used to prepare two cast PUs using two different curing regimens, and properties of the resulting cast PUs were evaluated. The resin and hardener components are in a percentage by weight (pbw) of 62:100 and a percentage by volume (pbv) of 1:2. TABLE 4 shows the processing properties of the cast urethane components. Processing and material temperatures were between about 65-80° F. (about 18-27° C.). Prior to use, the material was stored in tightly sealed containers between 65-90° F. (about 18-32° C.), and kept away from moisture or high humidity.

TABLE 4

| | | Resin | Hardener |
|---|---|---|---|
| | | (Isocyanate) | (Polyol) |
| Mix Ratio | pbw | 62 | 100 |
| | pbv | 50 | 100 |
| Density | g/cm³ | 1.22 | 0.98 |
| Viscosity at 77° F. | cP | 650 | 1,400 |

| | | Mixture |
|---|---|---|
| Mix Viscosity at 77° F. | cP | 800 |

Each of the hardener and resin components was agitated well before combining together (compounding). After compounding, the components were together mixed well before curing. The mold or substrate in which the compounded resin/hardener is poured was also checked to ensure that the mold or substrate was free of dirt, oil, and grease. In some cases, mold release agents were used.

The appearance, biobased carbon content, hardness, gel time, and demold time for quick and slow cure formulations are shown in TABLE 5. Molded samples prepared from these formulations were allowed to gel and subsequently demolded according to the times and at the temperature indicated in TABLE 5. Samples were subsequently heated for 30 minutes at 75° C., as opposed to longer cure times at room temperature or accelerated curing at higher temperatures, to mimic potential heat and time profiles in a manufacturing setting. The mechanical properties of the resultant products were measured at 2° C. (low temperature) and at 25° C. (room temperature). These data are shown in TABLE 5.

TABLE 5

| | | Quick Cure | | Slow Cure | |
|---|---|---|---|---|---|
| | | Formulation | | Formulation | |
| Appearance | visual | Tan | | Tan | |
| Biobased Content | % | 58 | | 58 | |
| Shore D Hardness | | 55-65 | | 65-70 | |
| Gel Time (23° C.) | min | 10 | | 45 | |
| Demold Time (23° C.) | hrs | 1 | | 24 | |
| | | Samples were held for 30 min at | | | |
| | | 75° C. before evaluation | | | |
| | | at the temperatures indicated | | | |
| | | 2° C. | 25° C. | 2° C. | 25° C. |
| Tensile Strength | psi | 2,890 | 1,815 | 6,680 | 4,180 |
| Elongation at Break | % | 22 | 38 | 9 | 25 |
| Flexural Strength | psi | 7,637 | 2,354 | 10,908 | 7,094 |

Both resins showed excellent physical properties, contained high biobased content as determined by ASTM 6866, and were essentially free of mercury, tin, MOCA (4,4′-methylenebis(2-chloroaniline), and TDI. While the resulting resins were tan in color, the resins were suitable for pigmentation. While the finish on the casted materials depends on the mold or substrate being used, the top surface on open-faced molds had a glossy finish, while a machined material had a buffy appearance. The finish of the casted material was improved by wiping with steel wool/acetone and/or silicone polish.

For both low temperature and room temperature testing, the slow cure formulation exhibited greater tensile strength, elongation at break, and flexural strength as compared to the quick cure formulation. Further, the performance of materials was better at low temperature, e.g., strength was greater at low temperature than at room temperature.

### Example 5. A Modified Cast Urethane Formulation

A cast urethane formulation comprised of components listed in TABLE 6 was prepared as follows. The algal polyol was prepared from an epoxidized ethanol ring opened high oleic algal oil (>88% C18:1, OH #149, EW 376). All components listed in TABLE 6, except isocyanate (Rubinate® M), including algal polyol, zeolites, 1,4-butanediol (1,4-BDO), and DBTDL, were charged in a cup in a dual centrifugal mixer and mixed for 40 sec at 3600 rpm. Subsequently, isocyanate was added and mixed for 20 sec at 3600 rpm. The resulting mixture was then poured in a stainless steel mold (10 cm×10 cm×0.2 cm). Samples were left in the mold at room temperature for 48 hours. Thereafter, the samples were demolded and cut in half. Half of the sample was post-cured in an oven at 110° C. for 15 hr, while the other half remained at room temperature.

TABLE 6

| | | | | | Rubinate M, |
|---|---|---|---|---|---|
| | Algal | Zeolites | 1,4-BDO | DBTDL (g), | Index 1.02 |
| | polyol (g), | (g), wt. % | (g), wt. % | 0.1 wt. % | (g), total |
| ID | total wt % | to polyol | to polyol | to polyol | wt % |
| 1 | 13, 72% | —, 0% | —, 0% | 0.013 | 5.07, 28% |
| 2 | 13, 69% | 0.65, 5% | —, 0% | 0.013 | 5.20, 28% |
| 3 | 13, 65% | 0.65, 5% | 0.26, 3% | 0.013 | 6.00, 30% |
| 4 | 13, 61% | 0.65, 5% | 0.56, 5% | 0.013 | 7.19, 34% |
| 5 | 20, 58% | 1.00, 5% | 1.40, 7% | 0.020 | 12.30, 35% |
| 6 | 20, 54% | 1.00, 5% | 2.00, 10% | 0.020 | 14.13, 38% |

Three coupons, approximately 50 mm (long)×2.0 mm (thick)×3.3 mm (wide), were prepared from each formulation and subjected to tensile testing (test speed 50 mm/min at room temperature), as well as Shore hardness and determination of T_{g} via DSC (3-cycle run, first two cycles: heating to 150° C. and cooling to −90° C. at a ramp of 20° C./min, the third cycle: heating to 120° C. at 10° C./min). The testing results for the room temperature (R.T.) and heat cured samples (heat) are shown in TABLE 7.

These data demonstrate that increasing levels of zeolites and diol (i.e., 1,4-BDO) improved physical properties. In addition, a longer heat cure regime resulted in materials with increased T_{g} and tensile strength, and a significant decrease in elongation at break.

TABLE 7

| | | Hardness, | Break Stress, | Elongation at |
|---|---|---|---|---|
| ID | T_{g}, ° C. | Shore D | MPa | Break, % |
| 1-R.T. | 7 | 36 ± 1 | 3.9 ± 0.5 | 56 ± 7 |
| 2-R.T. | 15 | 53 ± 2 | 5.9 ± 0.2 | 51 ± 4 |
| 3-R.T. | 15 | 61 ± 4 | 8.8 ± 1.0 | 49 ± 3 |
| 4-R.T. | 31 | 63 ± 1 | 11.4 ± 1.5 | 39 ± 5 |
| 5-R.T. | 33 | 62 ± 1 | 16.5 ± 1.7 | 79 ± 9 |
| 6-R.T. | 35 | 65 ± 1 | 18.4 ± 0.6 | 76 ± 3 |
| 1-Heat | 16 | 47 ± 1 | 7.0 ± 0.2 | 56 ± 1 |
| 2-Heat | 24 | 61 ± 1 | 12.4 ± 1.2 | 45 ± 5 |
| 3-Heat | 33 | 67 ± 1 | 14.7 ± 0.2 | 22 ± 1 |
| 4-Heat | 38 | 70 ± 1 | 24.3 ± 1.8 | 7 ± 1 |
| 5-Heat | 44 | 75 ± 1 | 31.1 ± 2.4 | 6 ± 1 |
| 6-Heat | 47 | 76 ± 1 | 29.9 ± 0.8 | 7 ± 4 |

### Embodiments

In some embodiments, the present disclosure provides a method for conversion of a microbial oil derived triglyceride oil having some degree of unsaturation into a polyol via chemical epoxidation followed by ring opening with base or an alcohol including, but not limited to ethanol, methanol, propanol, or isopropanol and combining said polyol with an isocyanate, in the absence of a blowing agent, such as water, cyclopentane, pentane, methylformate, or dimethoxymethane, to create a pourable, flowable, non-foaming, polyurethane resin.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 25° C., removing the cured resin, said resin having assumed the dimensions of the mold, possessing a Shore D hardness greater than 35 and a tensile strength greater than 560 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 25° C., removing the cured resin, said resin having assumed the dimensions of the mold, possessing a Shore D hardness greater than 35 and a tensile strength greater than 560 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 47 and a tensile strength greater than 1015 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 47 and a tensile strength greater than 1015 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 50 and a tensile strength greater than 2000 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 50 and a tensile strength greater than 2000 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 60 and a tensile strength greater than 3000 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 60 and a tensile strength greater than 3000 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 60 and a tensile strength greater than 4000 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 60 and a tensile strength greater than 4000 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 67 and a tensile strength greater than 4900 psi.

In some embodiments, the present disclosure provides a method for preparing a microbial oil derived resin, and casting said resin into a mold comprised of wood, wood-foam laminate, metal, or other thermoset or thermoplastic material and allowing the resin to cure at a temperature not greater than 110° C., removing the cured resin, said resin having assumed the dimensions of the mold, possessing a Shore D hardness greater than 67 and a tensile strength greater than 4900 psi and incorporating said material into the sidewall of an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 25° C., and incorporating the cured resin and material into which it was cast, into the final product, said resin having assumed the dimensions of the mold, possessing a Shore D hardness greater than 35 and a tensile strength greater than 560 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 25° C., and incorporating the cured resin and material into which it was cast, into the final product, said resin having assumed the dimensions of the mold, possessing a Shore D hardness greater than 35 and a tensile strength greater than 560 psi whereby the cast resin serves as a sidewall material in an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 47 and a tensile strength greater than 1015 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 47 and a tensile strength greater than 1015 psi, whereby the cast resin serves as a sidewall material in an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 50 and a tensile strength greater than 2000 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 50 and a tensile strength greater than 2000 psi, whereby the cast resin serves as a sidewall material in an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 60 and a tensile strength greater than 3000 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 60 and a tensile strength greater than 3000 psi, whereby the cast resin serves as a sidewall material in an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 60 and a tensile strength greater than 4000 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 60 and a tensile strength greater than 4000 psi, whereby the cast resin serves as a sidewall material in an alpine ski, touring or cross country ski, approach ski, split board, snowboard, or water ski, for example.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 67 and a tensile strength greater than 4900 psi.

In some embodiments, the present disclosure provides a method for preparing a microbial oil derived resin, and casting said resin into any receptacle comprised of wood, wood-foam laminate, metal, or other thermoset or thermoplastic material such that the final cast material and surrounding receptacle comprise at least a portion of the finished product, allowing the resin to cure at a temperature not greater than 110° C., and incorporating the cured resin and material into which it was cast, into the final product, said resin having assumed the dimensions of the mold, possessing a Shore D hardness greater than 67 and a tensile strength greater than 4900 psi, whereby the cast resin serves as a sidewall material in an alpine ski, touring or cross country ski, approach ski, split board, snowboard, or water ski, for example.

Embodiment 1. A sporting goods equipment comprising a polyurethane resin derived from a microbial oil.

Embodiment 2. The sporting goods equipment of embodiment 1, wherein said sporting goods equipment comprises a sidewall and said sidewall comprises said polyurethane resin.

Embodiment 3. The sporting goods equipment of embodiment 1 or 2, wherein one or more components of said sporting goods equipment is held together by a resin comprising said polyurethane resin.

Embodiment 4. The sporting goods equipment of any one of embodiments 1-3, wherein said polyurethane resin is molded onto one or more components of said sporting goods equipment.

Embodiment 5. The sporting goods equipment of any one of embodiments 1-4, wherein said polyurethane resin is molded onto one or more components of said sporting goods equipment with heat and/or pressure.

Embodiment 6. The sporting goods equipment of any one of embodiments 3-5, wherein said one or more components of said sporting goods equipment are composed of a solid material.

Embodiment 7. The sporting goods equipment of embodiment 6, wherein said solid material is a plastic, a fibrous material, a metal, an elastomeric material, or a thermoset material.

Embodiment 8. The sporting goods equipment of embodiment 7, wherein said plastic is polyurethane, polyethylene, or thermoplastic.

Embodiment 9. The sporting goods equipment of embodiment 7, wherein said metal is comprised of steel, titanium, aluminum, or an alloy thereof.

Embodiment 10. The sporting goods equipment of embodiment 7, wherein said fibrous material is wood, fiberglass, carbon fiber, Kevlar, flax, hemp, or wool.

Embodiment 11. The sporting goods equipment of embodiment 10, wherein said wood is selected from the group consisting of: paulownia, aspen, cherry, birch, alder, fuma, ash, box elder, chestnut, elm, hickory, koa, mahogany, sweetgum, oak, ash, beech, maple, poplar, walnut, pine, cedar, yew, fir, Douglas fir, larch, hardwood, bamboo, blackwood, bloodwood, basswood, boxelder, boxwood, brazilwood, coachwood, cocobolo, corkwood, cottonwood, dogwood, ironwood, kingwood, lacewood, marblewood, sandalwood, rosewood, zebrawood, ebony, ivory, buckeye, satinwood, kauri, spruce, cypress, hemlock, redwood, rimu, teak, eucalyptus, and willow.

Embodiment 12. The sporting goods equipment of embodiment 10, wherein said wood is paulownia.

Embodiment 13. The sporting goods equipment of embodiment 10, wherein said wood is aspen.

Embodiment 14. The sporting goods equipment of embodiment 10, wherein said wood comprises paulownia and aspen.

Embodiment 15. The sporting goods equipment of any one of embodiments 1-14, wherein said microbial oil comprises triacylglycerol (TAG) species having a fatty acid profile comprising one or more unsaturated fatty acids.

Embodiment 16. The sporting goods equipment of embodiment 15, wherein said fatty acid profile comprises at least 60% of one or more unsaturated fatty acids.

Embodiment 17. The sporting goods equipment of any one of embodiments 1-16, wherein said microbial oil comprises up to nine TAG species present in amounts of 1% or more in said microbial oil, wherein said up to nine TAG species present in amounts of 1% or more have a fatty acid profile comprising one or more unsaturated fatty acids.

Embodiment 18. The sporting goods equipment of any one of embodiments 1-16, wherein said microbial oil comprises up to nine TAG species.

Embodiment 19. The sporting goods equipment of any one of embodiments 1-16, wherein said microbial oil comprises up to four TAG species.

Embodiment 20. The sporting goods equipment of any one of embodiments 1-16, wherein said microbial oil comprises up to two TAG species comprising at least about 85% of total TAG species.

Embodiment 21. The sporting goods equipment of any one of embodiments 1-16, wherein said microbial oil consists of one TAG species comprising at least about 65% of total TAG species.

Embodiment 22. The sporting goods equipment of any one of embodiments 15-21, wherein said fatty acid profile comprises at least 60% to at least 90% of said one or more unsaturated fatty acids.

Embodiment 23. The sporting goods equipment of any one of embodiments 15-22, wherein said one or more unsaturated fatty acid species is selected from the group consisting of myristoleic acid, palmitoleic acid, sapienic acid, oleic acid, elaidic acid, vaccenic acid, petroselinic acid, eicosenoic (gondoic) acid, paullinic acid, gadoleic acid, erucic acid, brassidic acid, nervonic acid, hexadecatrienoic acid, linoleic acid, linolelaidic acid, α-linolenic acid, pinolenic acid, stearidonic acid, eicosadienoic acid, mead acid, eicosatrienoic acid, dihomo-γ-linolenic acid, podocarpic acid, arachidonic acid, eicosatetraenoic acid, eicosapentaenoic acid, heneicosapentaenoic acid, docosadienoic acid, adrenic acid, docosapentaenoic acid (osbond acid), docosahexaenoic acid, docosahexaenoic acid, tetracosatetraenoic acid, and tetracosapentaenoic acid.

Embodiment 24. The sporting goods equipment of any one of embodiments 15-22, wherein said one or more unsaturated fatty acid species is selected from the group consisting of: a 16:1 fatty acid, a 16:2 fatty acid, a 16:3 fatty acid, an 18:1 fatty acid, an 18:2 fatty acid, an 18:3 fatty acid, an 18:4 fatty acid, a 20:1 fatty acid, a 20:2 fatty acid, a 20:3 fatty acid, a 22:1 fatty acid, a 22:2 fatty acid, a 22:3 fatty acid, a 24:1 fatty acid, a 24:2 fatty acid, and a 24:3 fatty acid.

Embodiment 25. The sporting goods equipment of any one of embodiments 15-22, wherein said one or more unsaturated fatty acid species is an 18:1 fatty acid.

Embodiment 26. The sporting goods equipment of any one of embodiments 15-22, wherein said one or more unsaturated fatty acid species is oleic acid.

Embodiment 27. The sporting goods equipment of any one of embodiments 1-26, wherein said microbial oil is derived from microalgae.

Embodiment 28. The sporting goods equipment of embodiment 27, wherein said microalgae is a species of a genus selected from the group consisting of: Chlorella sp., Pseudochlorella sp., Heterochlorella sp., Prototheca sp., Arthrospira sp., Euglena sp., Nannochloropsis sp., Phaeodactylum sp., Chlamydomonas sp., Scenedesmus sp., Ostreococcus sp., Selenastrum sp., Haematococcus sp., Nitzschia, Dunaliella, Navicula sp., Trebouxia sp., Pseudotrebouxia sp., Vavicula sp., Bracteococcus sp., Gomphonema sp., Watanabea, sp., Botryococcus sp., Tetraselmis sp., and Isochrysis sp.

Embodiment 29. The sporting goods equipment of any one of embodiments 1-26, wherein said microbial oil is derived from oleaginous yeast.

Embodiment 30. The sporting goods equipment of any one of embodiments 1-26, wherein said microbial oil is derived from oleaginous bacteria.

Embodiment 31. The sporting goods equipment of any one of embodiments 1-30, wherein said microbial oil is derived from a genetically modified microbe.

Embodiment 32. The sporting goods equipment of any one of embodiments 1-30, wherein said microbial oil is derived from a non-genetically modified microbe.

Embodiment 33. The sporting goods equipment of any one of embodiments 1-32, wherein said polyurethane resin has a Shore D hardness that is greater than 35.

Embodiment 34. The sporting goods equipment of any one of embodiments 1-32, wherein said polyurethane resin has a Shore D hardness that is greater than 47.

Embodiment 35. The sporting goods equipment of any one of embodiments 1-32, wherein said polyurethane resin has a Shore D hardness that is greater than 50.

Embodiment 36. The sporting goods equipment of any one of embodiments 1-32, wherein said polyurethane resin has a Shore D hardness that is greater than 60.

Embodiment 37. The sporting goods equipment of any one of embodiments 1-32, wherein said polyurethane resin has a Shore D hardness that is greater than 67.

Embodiment 38. The sporting goods equipment of any one of embodiments 1-37, wherein said polyurethane resin has a tensile strength that is greater than 560 psi.

Embodiment 39. The sporting goods equipment of any one of embodiments 1-37, wherein said polyurethane resin has a tensile strength that is greater than 1015 psi.

Embodiment 40. The sporting goods equipment of any one of embodiments 1-37, wherein said polyurethane resin has a tensile strength that is greater than 2000 psi.

Embodiment 41. The sporting goods equipment of any one of embodiments 1-37, wherein said polyurethane resin has a tensile strength that is greater than 3000 psi.

Embodiment 42. The sporting goods equipment of any one of embodiments 1-37, wherein said polyurethane resin has a tensile strength that is greater than 4000 psi.

Embodiment 43. The sporting goods equipment of any one of embodiments 1-37, wherein said polyurethane resin has a tensile strength that is greater than 4900 psi.

Embodiment 44. The sporting goods equipment of any one of embodiments 1-43, wherein said sporting goods equipment is a ski, a snowboard, a split board, a skateboard, a wakeboard, or a kiteboard.

Embodiment 45. The sporting goods equipment of any one of embodiments 1-43, wherein said sporting goods equipment is a ski.

Embodiment 46. The sporting goods equipment of embodiment 45, wherein said ski is an alpine ski, a touring ski, a backcountry ski, a cross country ski, an all-mountain ski, an approach ski, or a water ski.

Embodiment 47. A method of producing said sporting goods equipment of any one of embodiments 1-46, comprising: polymerizing a polyol derived from said microbial oil with an isocyanate, thereby generating said polyurethane resin; and incorporating said polyurethane resin to one or more components of said sporting goods equipment to produce said sporting goods equipment.

Embodiment 48. The method of embodiment 47, wherein said polymerizing of said polyol is in absence of a blowing agent.

Embodiment 49. The method of embodiment 48, wherein said blowing agent is selected from the group consisting of: water, a hydrocarbon, liquid carbon dioxide, azodicarbonamide, hydrazine, and sodium bicarbonate.

Embodiment 50. The method of any one of embodiments 47-49, wherein said polymerization comprises reacting an amount of said isocyanate with said polyol to yield a polymer, wherein said polymer is a pre-polymer comprising at least one isocyanate.

Embodiment 51. The method of any one of embodiments 47-50, further comprising subjecting said microbial oil to epoxidation and ring opening, thereby generating said polyol.

Embodiment 52. The method of embodiment 51, wherein said epoxidation and ring opening comprises reacting with a base or an alcohol.

Embodiment 53. The method of embodiment 51, wherein said epoxidation and ring opening comprises reacting with ethanol.

Embodiment 54. The method of embodiment 51, wherein said epoxidation and ring opening comprises reacting with methanol.

Embodiment 55. The method of any one of embodiments 47-50, further comprising hydroformylating and hydrogenating said microbial oil, thereby generating said polyol.

Embodiment 56. The method of embodiment 55, wherein said hydroformylation occurs in presence of carbon monoxide and a catalyst.

Embodiment 57. The method of embodiment 55, wherein said hydrogenation comprises reduction with hydrogen gas, thereby generating said polyol.

Embodiment 58. The method of any one of embodiments 47-57, further comprising casting said polyurethane resin into a mold such that said polyurethane resin takes a shape of said mold.

Embodiment 59. The method of any one of embodiments 47-58, further comprising casting said polyurethane resin onto said one or more components of said sporting goods equipment.

Embodiment 60. The method of any one of embodiments 47-59, wherein said one or more components of said sporting goods equipment are composed of a solid material.

Embodiment 61. The method of embodiment 60, wherein said solid material is a plastic, a metal, a fibrous material, an elastomeric material, or a thermoset material.

Embodiment 62. The method of embodiment 61, wherein said plastic is polyurethane, polyethylene, or thermoplastic.

Embodiment 63. The method of embodiment 61, wherein said metal is comprised of steel, titanium, aluminum, or an alloy thereof.

Embodiment 64. The method of embodiment 61, wherein said fibrous material is wood, fiberglass, carbon fiber, Kevlar, flax, hemp, or wool.

Embodiment 65. The method of embodiment 64, wherein said wood is selected from the group consisting of: paulownia, aspen, cherry, birch, alder, fuma, ash, box elder, chestnut, elm, hickory, koa, mahogany, sweetgum, oak, ash, beech, maple, poplar, walnut, pine, cedar, yew, fir, Douglas fir, larch, hardwood, bamboo, blackwood, bloodwood, basswood, boxelder, boxwood, brazilwood, coachwood, cocobolo, corkwood, cottonwood, dogwood, ironwood, kingwood, lacewood, marblewood, sandalwood, rosewood, zebrawood, ebony, ivory, buckeye, satinwood, kauri, spruce, cypress, hemlock, redwood, rimu, teak, eucalyptus, and willow.

Embodiment 66. The method of embodiment 64, wherein said wood is paulownia.

Embodiment 67. The method of embodiment 64, wherein said wood is aspen.

Embodiment 68. The method of embodiment 64, wherein said wood comprises paulownia and aspen.

Embodiment 69. The method of any one of embodiments 47-68, further comprising curing said polyurethane resin in a mold.

Embodiment 70. The method of embodiment 69, wherein said curing is at a temperature of 20° C. to 25° C.

Embodiment 71. The method of embodiment 69, wherein said curing is at a temperature of 25° C. to 110° C.

Embodiment 72. The method of embodiment 69, wherein said curing is at a temperature that is not greater than 25° C.

Embodiment 73. The method of embodiment 69, wherein said curing is at a temperature that is not greater than 110° C.

Embodiment 74. The method of any one of embodiments 47-73, further comprising assembling said sporting goods equipment in a mold for a duration of 10 minutes to 60 minutes.

Embodiment 75. The method of any one of embodiment 47-74, further comprising assembling said sporting goods equipment in a pressurized mold at a pressure of 20 psi to 90 psi.

Embodiment 76. The method of any one of embodiment 48-75, further comprising assembling said sporting goods equipment in a heated mold at a temperature of 50° C. to 100° C.

Embodiment A1. A method for producing a cast polyurethane resin, the method comprising preparing a reaction mixture that comprises:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol,
   thereby producing the cast polyurethane resin.

Embodiment A2. The method of embodiment A1, wherein the polyol is at an amount of about 54% to about 72% on a weight-by-weight basis of the reaction mixture.

Embodiment A3. The method of embodiment A1 or A2, wherein the polyol is a biobased polyol.

Embodiment A4. The method of any one of embodiments A1-A3, wherein the polyol is a TAG polyol.

Embodiment A5. The method of any one of embodiments A1-A4, wherein the polyol is derived from a microbial triglyceride oil.

Embodiment A6. The method of any one of embodiments A1-A4, wherein the polyol is derived from an algal triglyceride oil.

Embodiment A7. The method of any one of embodiments A1-A6, further comprising obtaining the polyol by epoxidation and ring opening of a triglyceride oil.

Embodiment A8. The method of any one of embodiments A1-A7, wherein the polyol has a C18:1 content of at least 60%.

Embodiment A9. The method of any one of embodiments A1-A7, wherein the polyol has a C18:1 content of at least 80%.

Embodiment A10. The method of any one of embodiments A1-A7, wherein the polyol has a C18:1 content of at least 90%.

Embodiment A11. The method of any one of embodiments A1-10, wherein the polyol is a TAG polyol with a hydroxyl number of 125 to 165.

Embodiment A12. The method of any one of embodiments A1-A10, wherein the polyol is a TAG polyol with a hydroxyl number of 145 to 165.

Embodiment A13. The method of any one of embodiments A1-A10, wherein the polyol is a TAG polyol with a hydroxyl number of 149.

Embodiment A14. The method of any one of embodiments A1-A13, wherein the isocyanate is at an amount of about 28% to about 38% on a weight-by-weight basis of the resin.

Embodiment A15. The method of any one of embodiments A1-A14, wherein the isocyanate is a monomeric isocyanate.

Embodiment A16. The method of any one of embodiments A1-A14, wherein the isocyanate is a polymeric isocyanate.

Embodiment A17. The method of any one of embodiments A1-A14, wherein the isocyanate is methylene diphenyl diisocyanate (MDI).

Embodiment A18. The method of any one of embodiments A1-A14, wherein the isocyanate is polymeric methylene diphenyl diisocyanate (MDI).

Embodiment A19. The method of any one of embodiments A1-A18, wherein the catalyst is at an amount of about 0.1% to about 0.5% on a weight-by-weight basis of the polyol.

Embodiment A20. The method of any one of embodiments A1-A18, wherein the catalyst is at an amount of about 0.1% on a weight-by-weight basis of the polyol.

Embodiment A21. The method of any one of embodiments A1-A18, wherein the catalyst is at an amount of about 0.5% to about 0.8% on a weight-by-weight basis of the polyol.

Embodiment A22. The method of any one of embodiments A1-A18, wherein the catalyst is at an amount of about 0.8% on a weight-by-weight basis of the polyol.

Embodiment A23. The method of any one of embodiments A1-A22, wherein the catalyst is an amine catalyst.

Embodiment A24. The method of any one of embodiments A1-A22, wherein the catalyst is 1,4-diazabicyclo[2.2.2]octane (DABCO).

Embodiment A25. The method of any one of embodiments A1-A22, wherein the catalyst is an organometallic catalyst.

Embodiment A26. The method of embodiment A25, wherein the organometallic catalyst is an organotin catalyst, an organozinc catalyst, or an organozirconium catalyst.

Embodiment A27. The method of any one of embodiments A1-A22, wherein the catalyst is an organotin catalyst.

Embodiment A28. The method of any one of embodiments A1-A22, wherein the catalyst is dibutyltin dilaurate (DBTDL).

Embodiment A29. The method of any one of embodiments A1-A28, wherein the zeolite is at an amount of about 1.25% on a weight-by-weight basis of the polyol.

Embodiment A30. The method of any one of embodiments A1-A28, wherein the zeolite at an amount of about 5% on a weight-by-weight basis of the polyol.

Embodiment A31. The method of any one of embodiments A1-A30, wherein the reaction mixture further comprises an alkyl diol.

Embodiment A32. The method of embodiment A31, wherein the alkyl diol is at an amount of about 0.1% to about 10% on a weight-by-weight basis of the polyol.

Embodiment A33. The method of embodiment A31 or A32, wherein the alkyl diol is 1,4-butanediol.

Embodiment A34. The method of embodiment A33, wherein the 1,4-butanediol is at an amount of about 1% to about 10% on a weight-by-weight basis of the polyol.

Embodiment A35. The method of embodiment A33, wherein the 1,4-butanediol is at an amount of about 1% to about 5% on a weight-by-weight basis of the polyol.

Embodiment A36. The method of embodiment A33, wherein the 1,4-butanediol is at an amount of about 3% on a weight-by-weight basis of the polyol.

Embodiment A37. The method of embodiment A33, wherein the 1,4-butanediol is at an amount of about 5% on a weight-by-weight basis of the polyol.

Embodiment A38. The method of embodiment A33, wherein the 1,4-butanediol is at an amount of about 7% on a weight-by-weight basis of the polyol.

Embodiment A39. The method of embodiment A33, wherein the 1,4-butanediol is at an amount of about 10% on a weight-by-weight basis of the polyol.

Embodiment A40. The method of any one of embodiments A1-A39, further comprising curing the reaction mixture at room temperature for at least 48 hours.

Embodiment A41. The method of any one of embodiments A1-A39, further comprising curing the reaction mixture at 75° C. for at least 30 minutes.

Embodiment A42. The method of any one of embodiments A1-A39, further comprising curing the reaction mixture at 110° C. for at least 15 hours.

Embodiment A43. A cast polyurethane resin produced by the method of any one of embodiments A1-A42.

Embodiment A44. The method of embodiment A43, wherein the cast polyurethane resin has a biobased content is at least about 50% as assessed by ASTM 6866.

Embodiment A45. The method of embodiment A43, wherein the cast polyurethane resin has a biobased content is about 50% to about 60% as assessed by ASTM 6866.

Embodiment A46. The method of embodiment A43, wherein the cast polyurethane resin has a biobased content is about 58% as assessed by ASTM 6866.

Embodiment A47. The method of any one of embodiments A43-A46, wherein the cast polyurethane resin has a glass transition temperature of at least 5° C. as assessed by DSC.

Embodiment A48. The method of any one of embodiments A43-A46, wherein the cast polyurethane resin has a glass transition temperature of about 5° C. to about 50° C. as assessed by DSC.

Embodiment A49. The method of any one of embodiments A43-A48, wherein the cast polyurethane resin has a Shore D hardness of at least 50 as assessed by durometer testing at about 2° C. or lower.

Embodiment A50. The method of any one of embodiments A43-A48, wherein the cast polyurethane resin has a Shore D hardness of at least 50 as assessed by durometer testing at room temperature.

Embodiment A51. The method of any one of embodiments A43-A50, wherein the cast polyurethane resin has a tensile strength of at least 500 psi as assessed by ASTM D638 at about 2° C. or lower.

Embodiment A52. The method of any one of embodiments A43-A50, wherein the cast polyurethane resin has a tensile strength of at least 500 psi as assessed by ASTM D638 at room temperature.

Embodiment A53. The method of any one of embodiments A43-A52, wherein the cast polyurethane resin has an elongation at break of at least 5% as assessed by ASTM D638 at about 2° C. or lower.

Embodiment A54. The method of any one of embodiments A43-A52, wherein the cast polyurethane resin has an elongation at break of at least 5% as assessed by ASTM D638 at room temperature.

Embodiment A55. The method of any one of embodiments A43-A54, wherein the cast polyurethane resin has a flexural strength of at least 2,000 psi as assessed by ASTM D638 at about 2° C. or lower.

Embodiment A56. The method of any one of embodiments A43-A54, wherein the cast polyurethane resin has a flexural strength of at least 2,000 psi as assessed by ASTM D638 at room temperature.

Embodiment A57. The method of any one of embodiments A43-A56, wherein the cast polyurethane resin has break stress of at least 3 MPa as assessed by ASTM D638 at about 2° C. or lower.

Embodiment A58. The method of any one of embodiments A43-A56, wherein the cast polyurethane resin has break stress of at least 3 MPa as assessed by ASTM D638 at room temperature.

Embodiment A59. A reaction mixture comprising:
a) a polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the polyol; and
d) a zeolite at an amount of about 0.1% to about 8% on a weight-by-weight basis of the polyol.

Embodiment A60. A cast polyurethane resin comprising:
a) a polyol component at an amount of about 50% to about 75% on a weight-by-weight basis of the cast polyurethane resin;
b) an isocyanate component at an amount of about 25% to about 40% on a weight-by-weight basis of the cast polyurethane resin;
c) a catalyst component at an amount of about 0.1% to about 1% on a weight-by-weight basis of the polyol; and
d) a zeolite at an amount of about 0.1% to about 8% on a weight-by-weight basis of the polyol.

Embodiment A61. A method for preparing a cast polyurethane resin, the method comprising reacting a polyol at an amount of about 50% to about 75% on a weight-by-weight basis of the cast polyurethane resin with an isocyanate at an amount of about 25% to about 40% on a weight-by-weight basis of the cast polyurethane resin and a zeolite at an amount of about 0.1% to about 8% on a weight-by-weight basis of the polyol in the presence of a catalyst at an amount of about 0.1% to about 1% on a weight-by-weight basis of the polyol, thereby preparing the cast polyurethane resin.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for producing a cast polyurethane resin, the method comprising preparing a reaction mixture that comprises:
a) a triglyceride (TAG) polyol at an amount of about 50% to about 75% on a weight-by-weight basis of the reaction mixture;
b) an isocyanate at an amount of about 25% to about 40% on a weight-by-weight basis of the reaction mixture;
c) a catalyst at an amount of about 0.1% to about 1% on a weight-by-weight basis of the TAG polyol; and
d) a zeolite at an amount of about 0.1% to about 8% on a weight-by-weight basis of the TAG polyol,
thereby producing the cast polyurethane resin.

2. The method of claim 1, wherein the TAG polyol is at an amount of about 50% to about 55% on a weight-by-weight basis of the reaction mixture.

3-5. (canceled)

6. The method of claim 1, wherein the TAG polyol is derived from an algal triglyceride oil.

7. The method of claim 1, further comprising obtaining the TAG polyol by epoxidation and ring opening of a triglyceride oil.

8. (canceled)

9. The method of claim 1, wherein the TAG polyol is derived from a TAG having a C18:1 content of at least 80%.

10. (canceled)

11. The method of claim 1, wherein the TAG polyol has a hydroxyl number of 125 to 165.

12-13. (canceled)

14. The method of claim 1, wherein the isocyanate is at an amount of about 35% to about 40% on a weight-by-weight basis of the cast polyurethane resin.

15-16. (canceled)

17. The method of claim 1, wherein the isocyanate is methylene diphenyl diisocyanate (MDI).

18. (canceled)

19. The method of claim 1, wherein the catalyst is at an amount of about 0.1% to about 0.5% on a weight-by-weight basis of the TAG polyol.

20-23. (canceled)

24. The method of claim 1, wherein the catalyst is 1,4-diazabicyclo[2.2.2]octane (DABCO).

25-29. (canceled)

30. The method of claim 1, wherein the zeolite is at an amount of about 5% on a weight-by-weight basis of the TAG polyol.

31. The method of claim 1, wherein the reaction mixture further comprises an alkyl diol at an amount of about 0.1% to about 10% on a weight-by-weight basis of the TAG polyol.

32. (canceled)

33. The method of claim 31, wherein the alkyl diol is 1,4-butanediol.

34-39. (canceled)

40. The method of claim 1, further comprising curing the reaction mixture at or above room temperature for at least 48 hours.

41. The method of claim 1, further comprising curing the reaction mixture at or above about 75° C. for at least 30 minutes.

42. The method of claim 1, further comprising curing the reaction mixture at or above about 110° C. for at least 15 hours.

43. A cast polyurethane resin produced by the method of claim 1.

44-48. (canceled)

49. The cast polyurethane resin of claim 43, wherein the cast polyurethane resin has a Shore D hardness of at least 50 as assessed by durometer testing at about 2° C. or lower.

50. The cast polyurethane resin of claim 43, wherein the cast polyurethane resin has a Shore D hardness of at least 50 as assessed by durometer testing at room temperature.

51. The cast polyurethane resin of claim 43, wherein the cast polyurethane resin has a tensile strength of at least 500 psi as assessed by ASTM D638 at about 2° C. or lower.

52. The cast polyurethane resin of claim 43, wherein the cast polyurethane resin has a tensile strength of at least 500 psi as assessed by ASTM D638 at room temperature.

53-59. (canceled)

60. A cast polyurethane resin comprising:
a) a polyol component at an amount of about 50% to about 75% on a weight-by-weight basis of the cast polyurethane resin;
b) an isocyanate component at an amount of about 25% to about 40% on a weight-by-weight basis of the cast polyurethane resin;
c) a catalyst component at an amount of about 0.1% to about 1% on a weight-by-weight basis of the polyol; and
d) a zeolite at an amount of about 0.1% to about 8% on a weight-by-weight basis of the polyol.

61. (canceled)

62. The method of claim 1, wherein the cast polyurethane resin has a biobased content of at least about 50% as assessed by ASTM 6866.

63. The method of claim 1, wherein the cast polyurethane resin has a Shore D hardness of at least 50 as assessed by durometer testing at about 2° C. or lower.

64. The method of claim 1, wherein the cast polyurethane resin has a Shore D hardness of at least 50 as assessed by durometer testing at room temperature.

65. The method of claim 1, wherein the cast polyurethane resin has a tensile strength of at least 500 psi as assessed by ASTM D638 at about 2° C. or lower.

66. The method of claim 1, wherein the cast polyurethane resin has a tensile strength of at least 500 psi as assessed by ASTM D638 at room temperature.

67. A sporting goods equipment comprising the cast polyurethane resin produced by the method of claim 1.

68. The sporting goods equipment of claim 67, wherein said sporting goods equipment is a ski, a snowboard, a split board, a skateboard, a wakeboard, or a kiteboard.
